(19) United States
(12) Patent Application Publication
(10) Pub. No.: US 2023/0273459 A1
(43) Pub. Date: Aug. 31, 2023

(54) LAMINATED GRADED INDEX EYEGLASS LENSES

(71) Applicant: Gradient Index Optical Inc., Fulton, MD (US)

(72) Inventor: Gregory D. COOPER, Fulton, MD (US)

(21) Appl. No.: 18/017,035

(22) PCT Filed: Jul. 21, 2021
(86) PCT No.: PCT/US2021/042613

§ 371 Date: Jan. 19, 2023

Related U.S. Application Data
(60) Provisional application No. 63/053,938, filed on Jul. 20, 2020.

(51) Int. Cl. G02C 7/02; G02B 1/11; B29D 11/00

(52) U.S. Cl. CPC G02C 7/022; G02B 1/11; B29D 11/0073; B29D 11/00432; B29D 11/00355; B29D 11/00865; G02C 2202/16

(57) ABSTRACT

Described are laminated graded index lenses comprising a graded index lens and a flexible film coupled to the graded index lens. Such lenses allow for improved manufacturability and material properties.

### CROSS-REFERENCE

This application claims the benefit of U.S. Provisional Application No. 63/053,938, filed Jul. 20, 2020, which is hereby incorporated by reference in its entirety herein.

### BACKGROUND

The ability of glass and plastic lenses, and coatings applied thereon, to focus light, filter light, or both, enable various uses as eyeglasses, optics, and scientific and industrial equipment.

### SUMMARY

One aspect provided herein is a laminated graded index lens comprising: a graded index lens having a primary surface and a secondary surface, wherein the primary surface, the secondary surface, or both are curved in at least a first dimension; and a flexible film coupled to at least one of the primary surface and the secondary surface of the graded index lens.

In some embodiments, the primary surface, the secondary surface, or both are further curved in a second dimension perpendicular to the first dimension. In some embodiments, the curvature of the primary surface and the secondary surface in the first dimension and in the second dimension are in the same direction. In some embodiments, the curvature of the primary surface and the secondary surface in the first dimension or in the second dimension are in opposite directions. In some embodiments, a radius of curvature varies across at least a portion of the primary surface, at least a portion of the secondary surface, or both in the first dimension, the second dimension, or both. In some embodiments, the laminated graded index lens has a concave surface, a convex surface, or both. In some embodiments, a focus of the graded index lens is at least partially independent of the curvature of the primary surface, the secondary surface, or both in the first dimension, the second dimension, or both. In some embodiments, a focus provided by the graded index lens is spherical, cylindrical, angled, prismatic, or a Zernike polynomial. In some embodiments, the flexible film is index matched to the graded index lens. In some embodiments, the flexible film comprises a flexible glass film or a flexible polymer film. In some embodiments, the flexible film further comprises an anti-reflective film, a hydrophobic film, a hard coat film, an oleophobic film, a hydrophobic film, a tint film, a polarizer film, a photochromatic film, a UV-blocking film, or any combination thereof, covering at least a portion of the graded index lens. In some embodiments, the laminated graded index comprises two or more of the anti-reflective film, a hydrophobic film, the hard coat film, the oleophobic film, the hydrophobic film, the tint film, the polarizer film, the photochromatic film, or the UV-blocking film. In some embodiments, the laminated graded index comprises the flexible polymer film, and wherein the flexible polymer film comprises PET, PEN, transparent polyimide, polyimide, or any combination thereof.

In some embodiments, at least a portion of the flexible film covers a portion of the graded index lens of about 5% to about 90%. In some embodiments, at least a portion of the flexible film covers a portion of the graded index lens of about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 10% to about 20%, about 10% to about 30%, about 10% to about 40%, about 10% to about 50%, about 10% to about 60%, about 10% to about 70%, about 10% to about 80%, about 10% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%, including increments therein. In some embodiments, at least a portion of the flexible film covers a portion of the graded index lens of about 5%, about 10%, about 20%, about 30%, about 40%, about 50%, about 60%, about 70%, about 80%, or about 90%. In some embodiments, at least a portion of the flexible film covers a portion of the graded index lens of at least about 5%, about 10%, about 20%, about 30%, about 40%, about 50%, about 60%, about 70%, or about 80%. In some embodiments, at least a portion of the flexible film covers a portion of the graded index lens of at most about 10%, about 20%, about 30%, about 40%, about 50%, about 60%, about 70%, about 80%, or about 90%.

In some embodiments, at least a portion of the flexible film is at least partially coupled to at least a portion of the graded index lens by an at least partially optically clear adhesive. In some embodiments, the graded lens is directly printed onto the flexible film. In some embodiments, the flexible film comprises one or more portions of the flexible film.

In some embodiments, the graded index lens, the flexible film, or both has a Mohs hardness of about 4 to about 7. In some embodiments, the graded index lens, the flexible film, or both has a Mohs hardness of about 4 to about 4.5, about 4 to about 5, about 4 to about 5.5, about 4 to about 6, about 4 to about 6.5, about 4 to about 7, about 4.5 to about 5, about 4.5 to about 5.5, about 4.5 to about 6, about 4.5 to about 6.5, about 4.5 to about 7, about 5 to about 5.5, about 5 to about 6, about 5 to about 6.5, about 5 to about 7, about 5.5 to about 6, about 5.5 to about 6.5, about 5.5 to about 7, about 6 to about 6.5, about 6 to about 7, or about 6.5 to about 7. In some embodiments, the graded index lens, the flexible film, or both has a Mohs hardness of about 4, about 4.5, about 5, about 5.5, about 6, about 6.5, or about 7. In some embodiments, the graded index lens, the flexible film, or both has a Mohs hardness of at least about 4, about 4.5, about 5, about 5.5, about 6, or about 6.5. In some embodiments, the graded index lens, the flexible film, or both has a Mohs hardness of at most about 4.5, about 5, about 5.5, about 6, about 6.5, or about 7.

In some embodiments, the graded index lens, the flexible film, or both has a Rockwell M hardness of about 50 to about 120. In some embodiments, the graded index lens, the flexible film, or both has a Rockwell M hardness of about 50 to about 55, about 50 to about 60, about 50 to about 65, about 50 to about 70, about 50 to about 75, about 50 to about 80, about 50 to about 85, about 50 to about 90, about 50 to about 100, about 50 to about 110, about 50 to about 120, about 55 to about 60, about 55 to about 65, about 55 to about 70, about 55 to about 75, about 55 to about 80, about 55 to about 85, about 55 to about 90, about 55 to about 100, about 55 to about 110, about 55 to about 120, about 60 to about 65, about 60 to about 70, about 60 to about 75, about 60 to about 80, about 60 to about 85, about 60 to about 90, about 60 to about 100, about 60 to about 110, about 60 to about 120, about 65 to about 70, about 65 to about 75, about 65 to about 80, about 65 to about 85, about 65 to about 90, about 65 to about 100, about 65 to about 110, about 65 to about 120, about 70 to about 75, about 70 to about 80, about 70 to about 85, about 70 to about 90, about 70 to about 100, about 70 to about 110, about 70 to about 120, about 75 to about 80, about 75 to about 85, about 75 to about 90, about 75 to about 100, about 75 to about 110, about 75 to about 120, about 80 to about 85, about 80 to about 90, about 80 to about 100, about 80 to about 110, about 80 to about 120, about 85 to about 90, about 85 to about 100, about 85 to about 110, about 85 to about 120, about 90 to about 100, about 90 to about 110, about 90 to about 120, about 100 to about 110, about 100 to about 120, or about 110 to about 120. In some embodiments, the graded index lens, the flexible film, or both has a Rockwell M hardness of about 50, about 55, about 60, about 65, about 70, about 75, about 80, about 85, about 90, about 100, about 110, or about 120. In some embodiments, the graded index lens, the flexible film, or both has a Rockwell M hardness of at least about 50, about 55, about 60, about 65, about 70, about 75, about 80, about 85, about 90, about 100, or about 110. In some embodiments, the graded index lens, the flexible film, or both has a Rockwell M hardness of at most about 55, about 60, about 65, about 70, about 75, about 80, about 85, about 90, about 100, about 110, or about 120.

In some embodiments, the graded index lens has a spherical component of the focus of about −0.25 D to about 0.25 D. In some embodiments, the graded index lens has a spherical component of the focus of about −0.25 D to about −0.2 D, about −0.25 D to about −0.15 D, about −0.25 D to about −0.1 D, about −0.25 D to about −0.05 D, about −0.25 D to about 0 D, about −0.25 D to about 0.05 D, about −0.25 D to about 0.1 D, about −0.25 D to about 0.15 D, about −0.25 D to about 0.2 D, about −0.25 D to about 0.25 D, about −0.2 D to about −0.15 D, about −0.2 D to about −0.1 D, about −0.2 D to about −0.05 D, about −0.2 D to about 0 D, about −0.2 D to about 0.05 D, about −0.2 D to about 0.1 D, about −0.2 D to about 0.15 D, about −0.2 D to about 0.2 D, about −0.2 D to about 0.25 D, about −0.15 D to about −0.1 D, about −0.15 D to about −0.05 D, about −0.15 D to about 0 D, about −0.15 D to about 0.05 D, about −0.15 D to about 0.1 D, about −0.15 D to about 0.15 D, about −0.15 D to about 0.2 D, about −0.15 D to about 0.25 D, about −0.1 D to about −0.05 D, about −0.1 D to about 0 D, about −0.1 D to about 0.05 D, about −0.1 D to about 0.1 D, about −0.1 D to about 0.15 D, about −0.1 D to about 0.2 D, about −0.1 D to about 0.25 D, about −0.05 D to about 0 D, about −0.05 D to about 0.05 D, about −0.05 D to about 0.1 D, about −0.05 D to about 0.15 D, about −0.05 D to about 0.2 D, about −0.05 D to about 0.25 D, about 0 D to about 0.05 D, about 0 D to about 0.1 D, about 0 D to about 0.15 D, about 0 D to about 0.2 D, about 0 D to about 0.25 D, about 0.05 D to about 0.1 D, about 0.05 D to about 0.15 D, about 0.05 D to about 0.2 D, about 0.05 D to about 0.25 D, about 0.1 D to about 0.15 D, about 0.1 D to about 0.2 D, about 0.1 D to about 0.25 D, about 0.15 D to about 0.2 D, about 0.15 D to about 0.25 D, or about 0.2 D to about 0.25 D, including increments therein. In some embodiments, the graded index lens has a spherical component of the focus of about −0.25 D, about −0.2 D, about −0.15 D, about −0.1 D, about −0.05 D, about 0 D, about 0.05 D, about 0.1 D, about 0.15 D, about 0.2 D, or about 0.25 D. In some embodiments, the graded index lens has a spherical component of the focus of at least about −0.25 D, about −0.2 D, about −0.15 D, about −0.1 D, about −0.05 D, about 0 D, about 0.05 D, about 0.1 D, about 0.15 D, or about 0.2 D. In some embodiments, the graded index lens has a spherical component of the focus of at most about −0.2 D, about −0.15 D, about −0.1 D, about −0.05 D, about 0 D, about 0.05 D, about 0.1 D, about 0.15 D, about 0.2 D, or about 0.25 D.

In some embodiments, the laminated graded index lens is for use as an eyeglass lens. In some embodiments, the graded index lens further comprises an eyeglass frame coupling feature configured to couple to an eyeglass frame.

In some embodiments, a surface of the graded index lens is isometric to the flexible film within about 1e-9% to about 10%. In some embodiments, a surface of the graded index lens is isometric to the flexible film within about 1% to about 0.1%, about 1% to about 0.01%, about 1% to about 0.001%, about 1% to about 0.0001%, about 1% to about 0.00001%, about 1% to about 0.000001%, about 1% to about 1e-7%, about 1% to about 1e-8%, about 1% to about 1e-9%, about 1% to about 10%, about 0.1% to about 0.01%, about 0.1% to about 0.001%, about 0.1% to about 0.0001%, about 0.1% to about 0.00001%, about 0.1% to about 0.000001%, about 0.1% to about 1e-7%, about 0.1% to about 1e-8%, about 0.1% to about 1e-9%, about 0.1% to about 10%, about 0.01% to about 0.001%, about 0.01% to about 0.0001%, about 0.01% to about 0.00001%, about 0.01% to about 0.000001%, about 0.01% to about 1e-7%, about 0.01% to about 1e-8%, about 0.01% to about 1e-9%, about 0.01% to about 10%, about 0.001% to about 0.0001%, about 0.001% to about 0.00001%, about 0.001% to about 0.000001%, about 0.001% to about 1e-7%, about 0.001% to about 1e-8%, about 0.001% to about 1e-9%, about 0.001% to about 10%, about 0.0001% to about 0.00001%, about 0.0001% to about 0.000001%, about 0.0001% to about 1e-7%, about 0.0001% to about 1e-8%, about 0.0001% to about 1e-9%, about 0.0001% to about 10%, about 0.00001% to about 0.000001%, about 0.00001% to about 1e-7%, about 0.00001% to about 1e-8%, about 0.00001% to about 1e-9%, about 0.00001% to about 10%, about 0.000001% to about 1e-7%, about 0.000001% to about 1e-8%, about 0.000001% to about 1e-9%, about 0.000001% to about 10%, about 1e-7% to about 1e-8%, about 1e-7% to about 1e-9%, about 1e-7% to about 10%, about 1e-8% to about 1e-9%, about 1e-8% to about 10%, or about 1e-9% to about 10%, including increments therein. In some embodiments, a surface of the graded index lens is isometric to the flexible film within about 1%, about 0.1%, about 0.01%, about 0.001%, about 0.0001%, about 0.00001%, about 0.000001%, about 1e-7%, about 1e-8%, about 1e-9%, or about 10%. In some embodiments, a surface of the graded index lens is isometric to the flexible film within at least about 1%, about 0.1%, about 0.01%, about 0.001%, about 0.0001%, about 0.00001%, about 0.000001%, about 1e-7%, about 1e-8%, or about 1e-9%. In some embodiments, a surface of the graded index lens is isometric to the flexible film within at most about 0.1%, about 0.01%, about 0.001%, about 0.0001%, about 0.00001%, about 0.000001%, about 1e-7%, about 1e-8%, about 1e-9%, or about 10%.

Another aspect provided herein is a laminated graded index lens comprising: a graded index lens having a primary surface and a secondary surface, wherein the primary surface, the secondary surface, or both are curved in a first dimension; and a flexible film coupled to at least one of the primary surface and the secondary surface of the graded index lens; wherein the graded index lens has a focus that is at least partially independent of the curvature of the primary surface of the graded index lens, the secondary surface of the graded index lens, or both in the first dimension.

In some embodiments, the primary surface, the secondary surface, or both are further curved in a second dimension perpendicular to the first dimension. In some embodiments, the curvature of the primary surface and the secondary surface in the first dimension or in the second dimension are in the same direction. In some embodiments, the curvature of the primary surface and the secondary surface in the first dimension or in the second dimension are in opposite directions. In some embodiments, a radius of curvature varies across at least a portion of the primary surface, at least a portion of the secondary surface, or both in the first dimension, the second dimension, or both. In some embodiments, the laminated graded index lens has a concave surface, a convex surface, or both. In some embodiments, a focus provided by the graded index lens is spherical, cylindrical, angled, prismatic, or a Zernike polynomial. In some embodiments, the flexible film is index matched to the graded index lens. In some embodiments, the flexible film comprises a flexible glass film or a flexible polymer film. In some embodiments, the flexible film further comprises an anti-reflective film, a hydrophobic film, a hard coat film, an oleophobic film, a hydrophobic film, a tint film, a polarizer film, a photochromatic film, a UV-blocking film, or any combination thereof, covering at least a portion of the flexible film, the graded index lens, or both. In some embodiments, the laminated graded index lens comprises two or more of the anti-reflective film, a hydrophobic film, the hard coat film, the oleophobic film, the hydrophobic film, the tint film, the polarizer film, the photochromatic film, or the UV-blocking film. In some embodiments, the laminated graded index lens comprises the flexible polymer film, and wherein the flexible polymer film comprises PET, PEN, transparent polyimide, polyimide, or any combination thereof.

In some embodiments, at least a portion of the flexible film covers a portion of the graded index lens of about 5% to about 90%. In some embodiments, at least a portion of the flexible film covers a portion of the graded index lens of about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 10% to about 20%, about 10% to about 30%, about 10% to about 40%, about 10% to about 50%, about 10% to about 60%, about 10% to about 70%, about 10% to about 80%, about 10% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%, including increments therein. In some embodiments, at least a portion of the flexible film covers a portion of the graded index lens of about 5%, about 10%, about 20%, about 30%, about 40%, about 50%, about 60%, about 70%, about 80%, or about 90%. In some embodiments, at least a portion of the flexible film covers a portion of the graded index lens of at least about 5%, about 10%, about 20%, about 30%, about 40%, about 50%, about 60%, about 70%, or about 80%. In some embodiments, at least a portion of the flexible film covers a portion of the graded index lens of at most about 10%, about 20%, about 30%, about 40%, about 50%, about 60%, about 70%, about 80%, or about 90%.

In some embodiments, at least a portion of the flexible film is at least partially coupled to at least a portion of the graded index lens by an at least partially optically clear adhesive. In some embodiments, the graded lens is directly printed onto the flexible film.

In some embodiments, the graded index lens, the flexible film, or both has a Mohs hardness of about 4 to about 7. In some embodiments, the graded index lens, the flexible film, or both has a Mohs hardness of about 4 to about 4.5, about 4 to about 5, about 4 to about 5.5, about 4 to about 6, about 4 to about 6.5, about 4 to about 7, about 4.5 to about 5, about 4.5 to about 5.5, about 4.5 to about 6, about 4.5 to about 6.5, about 4.5 to about 7, about 5 to about 5.5, about 5 to about 6, about 5 to about 6.5, about 5 to about 7, about 5.5 to about 6, about 5.5 to about 6.5, about 5.5 to about 7, about 6 to about 6.5, about 6 to about 7, or about 6.5 to about 7. In some embodiments, the graded index lens, the flexible film, or both has a Mohs hardness of about 4, about 4.5, about 5, about 5.5, about 6, about 6.5, or about 7. In some embodiments, the graded index lens, the flexible film, or both has a Mohs hardness of at least about 4, about 4.5, about 5, about 5.5, about 6, or about 6.5. In some embodiments, the graded index lens, the flexible film, or both has a Mohs hardness of at most about 4.5, about 5, about 5.5, about 6, about 6.5, or about 7.

In some embodiments, the graded index lens, the flexible film, or both has a Rockwell M hardness of about 50 to about 120. In some embodiments, the graded index lens, the flexible film, or both has a Rockwell M hardness of about 50 to about 55, about 50 to about 60, about 50 to about 65, about 50 to about 70, about 50 to about 75, about 50 to about 80, about 50 to about 85, about 50 to about 90, about 50 to about 100, about 50 to about 110, about 50 to about 120, about 55 to about 60, about 55 to about 65, about 55 to about 70, about 55 to about 75, about 55 to about 80, about 55 to about 85, about 55 to about 90, about 55 to about 100, about 55 to about 110, about 55 to about 120, about 60 to about 65, about 60 to about 70, about 60 to about 75, about 60 to about 80, about 60 to about 85, about 60 to about 90, about 60 to about 100, about 60 to about 110, about 60 to about 120, about 65 to about 70, about 65 to about 75, about 65 to about 80, about 65 to about 85, about 65 to about 90, about 65 to about 100, about 65 to about 110, about 65 to about 120, about 70 to about 75, about 70 to about 80, about 70 to about 85, about 70 to about 90, about 70 to about 100, about 70 to about 110, about 70 to about 120, about 75 to about 80, about 75 to about 85, about 75 to about 90, about 75 to about 100, about 75 to about 110, about 75 to about 120, about 80 to about 85, about 80 to about 90, about 80 to about 100, about 80 to about 110, about 80 to about 120, about 85 to about 90, about 85 to about 100, about 85 to about 110, about 85 to about 120, about 90 to about 100, about 90 to about 110, about 90 to about 120, about 100 to about 110, about 100 to about 120, or about 110 to about 120. In some embodiments, the graded index lens, the flexible film, or both has a Rockwell M hardness of about 50, about 55, about 60, about 65, about 70, about 75, about 80, about 85, about 90, about 100, about 110, or about 120. In some embodiments, the graded index lens, the flexible film, or both has a Rockwell M hardness of at least about 50, about 55, about 60, about 65, about 70, about 75, about 80, about 85, about 90, about 100, or about 110. In some embodiments, the graded index lens, the flexible film, or both has a Rockwell M hardness of at most about 55, about 60, about 65, about 70, about 75, about 80, about 85, about 90, about 100, about 110, or about 120.

In some embodiments, the graded index lens has a spherical component of the focus of about −0.25 D to about 0.25 D. In some embodiments, the graded index lens has a spherical component of the focus of about −0.25 D to about −0.2 D, about −0.25 D to about −0.15 D, about −0.25 D to about −0.1 D, about −0.25 D to about −0.05 D, about −0.25 D to about 0 D, about −0.25 D to about 0.05 D, about −0.25 D to about 0.1 D, about −0.25 D to about 0.15 D, about −0.25 D to about 0.2 D, about −0.25 D to about 0.25 D, about −0.2 D to about −0.15 D, about −0.2 D to about −0.1 D, about −0.2 D to about −0.05 D, about −0.2 D to about 0 D, about −0.2 D to about 0.05 D, about −0.2 D to about 0.1 D, about −0.2 D to about 0.15 D, about −0.2 D to about 0.2 D, about −0.2 D to about 0.25 D, about −0.15 D to about −0.1 D, about −0.15 D to about −0.05 D, about −0.15 D to about 0 D, about −0.15 D to about 0.05 D, about −0.15 D to about 0.1 D, about −0.15 D to about 0.15 D, about −0.15 D to about 0.2 D, about −0.15 D to about 0.25 D, about −0.1 D to about −0.05 D, about −0.1 D to about 0 D, about −0.1 D to about 0.05 D, about −0.1 D to about 0.1 D, about −0.1 D to about 0.15 D, about −0.1 D to about 0.2 D, about −0.1 D to about 0.25 D, about −0.05 D to about 0 D, about −0.05 D to about 0.05 D, about −0.05 D to about 0.1 D, about −0.05 D to about 0.15 D, about −0.05 D to about 0.2 D, about −0.05 D to about 0.25 D, about 0 D to about 0.05 D, about 0 D to about 0.1 D, about 0 D to about 0.15 D, about 0 D to about 0.2 D, about 0 D to about 0.25 D, about 0.05 D to about 0.1 D, about 0.05 D to about 0.15 D, about 0.05 D to about 0.2 D, about 0.05 D to about 0.25 D, about 0.1 D to about 0.15 D, about 0.1 D to about 0.2 D, about 0.1 D to about 0.25 D, about 0.15 D to about 0.2 D, about 0.15 D to about 0.25 D, or about 0.2 D to about 0.25 D, including increments therein. In some embodiments, the graded index lens has a spherical component of the focus of about −0.25 D, about −0.2 D, about −0.15 D, about −0.1 D, about −0.05 D, about 0 D, about 0.05 D, about 0.1 D, about 0.15 D, about 0.2 D, or about 0.25 D. In some embodiments, the graded index lens has a spherical component of the focus of at least about −0.25 D, about −0.2 D, about −0.15 D, about −0.1 D, about −0.05 D, about 0 D, about 0.05 D, about 0.1 D, about 0.15 D, or about 0.2 D. In some embodiments, the graded index lens has a spherical component of the focus of at most about −0.2 D, about −0.15 D, about −0.1 D, about −0.05 D, about 0 D, about 0.05 D, about 0.1 D, about 0.15 D, about 0.2 D, or about 0.25 D.

In some embodiments, the laminated graded index lens is for use as an eyeglass lens. In some embodiments, the graded index lens further comprises an eyeglass frame coupling feature configured to couple to an eyeglass frame.

In some embodiments, a surface of the graded index lens is isometric to the flexible film within about 1e-9% to about 10%. In some embodiments, a surface of the graded index lens is isometric to the flexible film within about 1% to about 0.1%, about 1% to about 0.01%, about 1% to about 0.001%, about 1% to about 0.0001%, about 1% to about 0.00001%, about 1% to about 0.000001%, about 1% to about 1e-7%, about 1% to about 1e-8%, about 1% to about 1e-9%, about 1% to about 10%, about 0.1% to about 0.01%, about 0.1% to about 0.001%, about 0.1% to about 0.0001%, about 0.1% to about 0.00001%, about 0.1% to about 0.000001%, about 0.1% to about 1e-7%, about 0.1% to about 1e-8%, about 0.1% to about 1e-9%, about 0.1% to about 10%, about 0.01% to about 0.001%, about 0.01% to about 0.0001%, about 0.01% to about 0.00001%, about 0.01% to about 0.000001%, about 0.01% to about 1e-7%, about 0.01% to about 1e-8%, about 0.01% to about 1e-9%, about 0.01% to about 10%, about 0.001% to about 0.0001%, about 0.001% to about 0.00001%, about 0.001% to about 0.000001%, about 0.001% to about 1e-7%, about 0.001% to about 1e-8%, about 0.001% to about 1e-9%, about 0.001% to about 10%, about 0.0001% to about 0.00001%, about 0.0001% to about 0.000001%, about 0.0001% to about 1e-7%, about 0.0001% to about 1e-8%, about 0.0001% to about 1e-9%, about 0.0001% to about 10%, about 0.00001% to about 0.000001%, about 0.00001% to about 1e-7%, about 0.00001% to about 1e-8%, about 0.00001% to about 1e-9%, about 0.00001% to about 10%, about 0.000001% to about 1e-7%, about 0.000001% to about 1e-8%, about 0.000001% to about 1e-9%, about 0.000001% to about 10%, about 1e-7% to about 1e-8%, about 1e-7% to about 1e-9%, about 1e-7% to about 10%, about 1e-8% to about 1e-9%, about 1e-8% to about 10%, or about 1e-9% to about 10%, including increments therein. In some embodiments, a surface of the graded index lens is isometric to the flexible film within about 1%, about 0.1%, about 0.01%, about 0.001%, about 0.0001%, about 0.00001%, about 0.000001%, about 1e-7%, about 1e-8%, about 1e-9%, or about 10%. In some embodiments, a surface of the graded index lens is isometric to the flexible film within at least about 1%, about 0.1%, about 0.01%, about 0.001%, about 0.0001%, about 0.00001%, about 0.000001%, about 1e-7%, about 1e-8%, or about 1e-9%. In some embodiments, a surface of the graded index lens is isometric to the flexible film within at most about 0.1%, about 0.01%, about 0.001%, about 0.0001%, about 0.00001%, about 0.000001%, about 1e-7%, about 1e-8%, about 1e-9%, or about 10%.

Another aspect provided herein is a laminated graded index lens comprising: a graded index lens having a primary surface and a secondary surface, wherein the primary surface, the secondary surface, or both are curved in a first dimension; and a flexible film coupled to at least one of the primary surface and the secondary surface of the graded index lens; wherein the graded index lens is printed onto at least a portion of the first flexible film.

In some embodiments, the primary surface, the secondary surface, or both are further curved in a second dimension perpendicular to the first dimension. In some embodiments, the curvature of the primary surface and the secondary surface in the first dimension or in the second dimension are in the same direction. In some embodiments, the curvature of the primary surface and the secondary surface in the first dimension or in the second dimension are in opposite directions. In some embodiments, a radius of curvature varies across at least a portion of the primary surface, at least a portion of the secondary surface, or both in the first dimension, the second dimension, or both. In some embodiments, the laminated graded index lens has a concave surface, a convex surface, or both. In some embodiments, a focus of the graded index lens is at least partially independent of the curvature of the primary surface, the secondary surface, or both in the first dimension, the second dimension, or both. In some embodiments, a focus provided by the graded index lens is spherical, cylindrical, angled, prismatic, or a Zernike polynomial. In some embodiments, the flexible film is index matched to the graded index lens. In some embodiments, the flexible film comprises a flexible glass film or a flexible polymer film. In some embodiments, the flexible film further comprises an anti-reflective film, a hydrophobic film, a hard coat film, an oleophobic film, a hydrophobic film, or any combination thereof, covering at least a portion of the flexible film, the graded index lens, or both. In some embodiments, the laminated graded index comprises two or more of the anti-reflective film, a hydrophobic film, the hard coat film, the oleophobic film, the hydrophobic film, the tint film, the polarizer film, the photochromatic film, or the UV-blocking film. In some embodiments, the laminated graded index comprises the flexible polymer film, and wherein the flexible polymer film comprises PET, PEN, transparent polyimide, polyimide, or any combination thereof.

In some embodiments, at least a portion of the flexible film covers a portion of the graded index lens of about 5% to about 90%. In some embodiments, at least a portion of the flexible film covers a portion of the graded index lens of about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 10% to about 20%, about 10% to about 30%, about 10% to about 40%, about 10% to about 50%, about 10% to about 60%, about 10% to about 70%, about 10% to about 80%, about 10% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%, including increments therein. In some embodiments, at least a portion of the flexible film covers a portion of the graded index lens of about 5%, about 10%, about 20%, about 30%, about 40%, about 50%, about 60%, about 70%, about 80%, or about 90%. In some embodiments, at least a portion of the flexible film covers a portion of the graded index lens of at least about 5%, about 10%, about 20%, about 30%, about 40%, about 50%, about 60%, about 70%, or about 80%. In some embodiments, at least a portion of the flexible film covers a portion of the graded index lens of at most about 10%, about 20%, about 30%, about 40%, about 50%, about 60%, about 70%, about 80%, or about 90%.

In some embodiments, at least a portion of the flexible film is at least partially coupled to at least a portion of the graded index lens by an at least partially optically clear adhesive.

In some embodiments, the graded index lens, the flexible film, or both has a Mohs hardness of about 4 to about 7. In some embodiments, the graded index lens, the flexible film, or both has a Mohs hardness of about 4 to about 4.5, about 4 to about 5, about 4 to about 5.5, about 4 to about 6, about 4 to about 6.5, about 4 to about 7, about 4.5 to about 5, about 4.5 to about 5.5, about 4.5 to about 6, about 4.5 to about 6.5, about 4.5 to about 7, about 5 to about 5.5, about 5 to about 6, about 5 to about 6.5, about 5 to about 7, about 5.5 to about 6, about 5.5 to about 6.5, about 5.5 to about 7, about 6 to about 6.5, about 6 to about 7, or about 6.5 to about 7. In some embodiments, the graded index lens, the flexible film, or both has a Mohs hardness of about 4, about 4.5, about 5, about 5.5, about 6, about 6.5, or about 7. In some embodiments, the graded index lens, the flexible film, or both has a Mohs hardness of at least about 4, about 4.5, about 5, about 5.5, about 6, or about 6.5. In some embodiments, the graded index lens, the flexible film, or both has a Mohs hardness of at most about 4.5, about 5, about 5.5, about 6, about 6.5, or about 7.

In some embodiments, the graded index lens, the flexible film, or both has a Rockwell M hardness of about 50 to about 120. In some embodiments, the graded index lens, the flexible film, or both has a Rockwell M hardness of about 50 to about 55, about 50 to about 60, about 50 to about 65, about 50 to about 70, about 50 to about 75, about 50 to about 80, about 50 to about 85, about 50 to about 90, about 50 to about 100, about 50 to about 110, about 50 to about 120, about 55 to about 60, about 55 to about 65, about 55 to about 70, about 55 to about 75, about 55 to about 80, about 55 to about 85, about 55 to about 90, about 55 to about 100, about 55 to about 110, about 55 to about 120, about 60 to about 65, about 60 to about 70, about 60 to about 75, about 60 to about 80, about 60 to about 85, about 60 to about 90, about 60 to about 100, about 60 to about 110, about 60 to about 120, about 65 to about 70, about 65 to about 75, about 65 to about 80, about 65 to about 85, about 65 to about 90, about 65 to about 100, about 65 to about 110, about 65 to about 120, about 70 to about 75, about 70 to about 80, about 70 to about 85, about 70 to about 90, about 70 to about 100, about 70 to about 110, about 70 to about 120, about 75 to about 80, about 75 to about 85, about 75 to about 90, about 75 to about 100, about 75 to about 110, about 75 to about 120, about 80 to about 85, about 80 to about 90, about 80 to about 100, about 80 to about 110, about 80 to about 120, about 85 to about 90, about 85 to about 100, about 85 to about 110, about 85 to about 120, about 90 to about 100, about 90 to about 110, about 90 to about 120, about 100 to about 110, about 100 to about 120, or about 110 to about 120. In some embodiments, the graded index lens, the flexible film, or both has a Rockwell M hardness of about 50, about 55, about 60, about 65, about 70, about 75, about 80, about 85, about 90, about 100, about 110, or about 120. In some embodiments, the graded index lens, the flexible film, or both has a Rockwell M hardness of at least about 50, about 55, about 60, about 65, about 70, about 75, about 80, about 85, about 90, about 100, or about 110. In some embodiments, the graded index lens, the flexible film, or both has a Rockwell M hardness of at most about 55, about 60, about 65, about 70, about 75, about 80, about 85, about 90, about 100, about 110, or about 120.

In some embodiments, the graded index lens has a spherical component of the focus of about −0.25 D to about 0.25 D. In some embodiments, the graded index lens has a spherical component of the focus of about −0.25 D to about −0.2 D, about −0.25 D to about −0.15 D, about −0.25 D to about −0.1 D, about −0.25 D to about −0.05 D, about −0.25 D to about 0 D, about −0.25 D to about 0.05 D, about −0.25 D to about 0.1 D, about −0.25 D to about 0.15 D, about −0.25 D to about 0.2 D, about −0.25 D to about 0.25 D, about −0.2 D to about −0.15 D, about −0.2 D to about −0.1 D, about −0.2 D to about −0.05 D, about −0.2 D to about 0 D, about −0.2 D to about 0.05 D, about −0.2 D to about 0.1 D, about −0.2 D to about 0.15 D, about −0.2 D to about 0.2 D, about −0.2 D to about 0.25 D, about −0.15 D to about −0.1 D, about −0.15 D to about −0.05 D, about −0.15 D to about 0 D, about −0.15 D to about 0.05 D, about −0.15 D to about 0.1 D, about −0.15 D to about 0.15 D, about −0.15 D to about 0.2 D, about −0.15 D to about 0.25 D, about −0.1 D to about −0.05 D, about −0.1 D to about 0 D, about −0.1 D to about 0.05 D, about −0.1 D to about 0.1 D, about −0.1 D to about 0.15 D, about −0.1 D to about 0.2 D, about −0.1 D to about 0.25 D, about −0.05 D to about 0 D, about −0.05 D to about 0.05 D, about −0.05 D to about 0.1 D, about −0.05 D to about 0.15 D, about −0.05 D to about 0.2 D, about −0.05 D to about 0.25 D, about 0 D to about 0.05 D, about 0 D to about 0.1 D, about 0 D to about 0.15 D, about 0 D to about 0.2 D, about 0 D to about 0.25 D, about 0.05 D to about 0.1 D, about 0.05 D to about 0.15 D, about 0.05 D to about 0.2 D, about 0.05 D to about 0.25 D, about 0.1 D to about 0.15 D, about 0.1 D to about 0.2 D, about 0.1 D to about 0.25 D, about 0.15 D to about 0.2 D, about 0.15 D to about 0.25 D, or about 0.2 D to about 0.25 D, including increments therein. In some embodiments, the graded index lens has a spherical component of the focus of about −0.25 D, about −0.2 D, about −0.15 D, about −0.1 D, about −0.05 D, about 0 D, about 0.05 D, about 0.1 D, about 0.15 D, about 0.2 D, or about 0.25 D. In some embodiments, the graded index lens has a spherical component of the focus of at least about −0.25 D, about −0.2 D, about −0.15 D, about −0.1 D, about −0.05 D, about 0 D, about 0.05 D, about 0.1 D, about 0.15 D, or about 0.2 D. In some embodiments, the graded index lens has a spherical component of the focus of at most about −0.2 D, about −0.15 D, about −0.1 D, about −0.05 D, about 0 D, about 0.05 D, about 0.1 D, about 0.15 D, about 0.2 D, or about 0.25 D.

In some embodiments, the laminated graded index lens is for use as an eyeglass lens. In some embodiments, the graded index lens further comprises an eyeglass frame coupling feature configured to couple to an eyeglass frame. In some embodiments, a surface of the graded index lens is isometric to the flexible film within about 1e-9% to about 10%. In some embodiments, a surface of the graded index lens is isometric to the flexible film within about 1% to about 0.1%, about 1% to about 0.01%, about 1% to about 0.001%, about 1% to about 0.0001%, about 1% to about 0.00001%, about 1% to about 0.000001%, about 1% to about 1e-7%, about 1% to about 1e-8%, about 1% to about 1e-9%, about 1% to about 10%, about 0.1% to about 0.01%, about 0.1% to about 0.001%, about 0.1% to about 0.0001%, about 0.1% to about 0.00001%, about 0.1% to about 0.000001%, about 0.1% to about 1e-7%, about 0.1% to about 1e-8%, about 0.1% to about 1e-9%, about 0.1% to about 10%, about 0.01% to about 0.001%, about 0.01% to about 0.0001%, about 0.01% to about 0.00001%, about 0.01% to about 0.000001%, about 0.01% to about 1e-7%, about 0.01% to about 1e-8%, about 0.01% to about 1e-9%, about 0.01% to about 10%, about 0.001% to about 0.0001%, about 0.001% to about 0.00001%, about 0.001% to about 0.000001%, about 0.001% to about 1e-7%, about 0.001% to about 1e-8%, about 0.001% to about 1e-9%, about 0.001% to about 10%, about 0.0001% to about 0.00001%, about 0.0001% to about 0.000001%, about 0.0001% to about 1e-7%, about 0.0001% to about 1e-8%, about 0.0001% to about 1e-9%, about 0.0001% to about 10%, about 0.00001% to about 0.000001%, about 0.00001% to about 1e-7%, about 0.00001% to about 1e-8%, about 0.00001% to about 1e-9%, about 0.00001% to about 10%, about 0.000001% to about 1e-7%, about 0.000001% to about 1e-8%, about 0.000001% to about 1e-9%, about 0.000001% to about 10%, about 1e-7% to about 1e-8%, about 1e-7% to about 1e-9%, about 1e-7% to about 10%, about 1e-8% to about 1e-9%, about 1e-8% to about 10%, or about 1e-9% to about 10%, including increments therein. In some embodiments, a surface of the graded index lens is isometric to the flexible film within about 1%, about 0.1%, about 0.01%, about 0.001%, about 0.0001%, about 0.00001%, about 0.000001%, about 1e-7%, about 1e-8%, about 1e-9%, or about 10%. In some embodiments, a surface of the graded index lens is isometric to the flexible film within at least about 1%, about 0.1%, about 0.01%, about 0.001%, about 0.0001%, about 0.00001%, about 0.000001%, about 1e-7%, about 1e-8%, or about 1e-9%. In some embodiments, a surface of the graded index lens is isometric to the flexible film within at most about 0.1%, about 0.01%, about 0.001%, about 0.0001%, about 0.00001%, about 0.000001%, about 1e-7%, about 1e-8%, about 1e-9%, or about 10%.

Another aspect provided herein is an eyeglass comprising a laminated graded index lens, the laminated graded index lens comprising: a graded index lens having a primary surface and a secondary surface, wherein the primary surface, the secondary surface, or both are curved in a first dimension; and a flexible film coupled to at least one of the primary surface and the secondary surface of the graded index lens; wherein the graded index lens has a thickness less than about 4.5 mm, a spherical component of focus of less than about 15D or greater than about −15D, a density less than about 2.1 g/cm3.

Another aspect provided herein is a pair of eyeglasses comprising: receiving the laminated graded index lens; and an eyeglass frame.

Another aspect provided herein is a method of forming a pair of eyeglasses, the method comprising: receiving the laminated graded index lens; receiving an eyeglass frame; and inserting the laminated graded index lens into the eyeglass frame.

Another aspect provided herein is a system comprising: the laminated graded index lens; and an optical instrument in contact with the laminated graded index lens.

Another aspect provided herein is a manufacturing facility for manufacturing the laminated graded index lens.

Another aspect provided herein is a method of forming a laminated graded index lens, the method comprising: printing a graded index lens onto at least a portion of a first flexible film; and coupling a second flexible film onto at least a portion of the graded index lens.

In some embodiments, the printing is performed by an inkjet printer, a 3-dimensional printer, or both. In some embodiments, the printing comprises printing an eyeglass coupling feature onto the graded index lens. In some embodiments, coupling the second flexible film onto the portion of the graded index lens comprises coupling the second flexible film by a roller. In some embodiments, the method comprises printing two or more graded index lenses onto the at least a portion of the first flexible film simultaneously. In some embodiments, the method comprises coupling the second flexible film onto at least a portion of two or more graded index lenses simultaneously. In some embodiments, the graded index lens comprises a concave surface, a convex surface, or both. In some embodiments, the first flexible film, the second flexible film, or both are index matched to the graded index lens. In some embodiments, the first flexible film, the second flexible film, or both comprises a flexible glass film or a flexible polymer film. In some embodiments, the first flexible film, the second flexible film, or both further comprises an anti-reflective film, a hydrophobic film, a hard coat film, an oleophobic film, a hydrophobic film, or any combination thereof, covering at least a portion of the flexible film, the graded index lens, or both. In some embodiments, the first flexible film, the second flexible film, or both comprise two or more of the anti-reflective film, a hydrophobic film, the hard coat film, the oleophobic film, the hydrophobic film, the tint film, the polarizer film, the photochromatic film, or the UV-blocking film. In some embodiments, the first flexible film, the second flexible film, or both comprise the flexible polymer film, and wherein the flexible polymer film comprises PET, PEN, transparent polyimide, polyimide, or any combination thereof.

In some embodiments, a part of the graded index lens covered by at least a portion of the first flexible film, the second flexible film, or both is about 5% to about 90%. In some embodiments, a part of the graded index lens covered by at least a portion of the first flexible film, the second flexible film, or both is about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 10% to about 20%, about 10% to about 30%, about 10% to about 40%, about 10% to about 50%, about 10% to about 60%, about 10% to about 70%, about 10% to about 80%, about 10% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%, including increments therein. In some embodiments, a part of the graded index lens covered by at least a portion of the first flexible film, the second flexible film, or both is about 5%, about 10%, about 20%, about 30%, about 40%, about 50%, about 60%, about 70%, about 80%, or about 90%. In some embodiments, a part of the graded index lens covered by at least a portion of the first flexible film, the second flexible film, or both is at least about 5%, about 10%, about 20%, about 30%, about 40%, about 50%, about 60%, about 70%, or about 80%. In some embodiments, a part of the graded index lens covered by at least a portion of the first flexible film, the second flexible film, or both is at most about 10%, about 20%, about 30%, about 40%, about 50%, about 60%, about 70%, about 80%, or about 90%.

In some embodiments, at least a portion of the first flexible film, the second flexible film, or both is at least partially coupled to at least a portion of the graded index lens by an at least partially optically clear adhesive. In some embodiments, the graded index lens, the first flexible film, the second flexible film, or any combination thereof has a Mohs hardness of about 4 to about 7, a Rockwell M hardness of about 50 to about 120, or both. In some embodiments, the graded index lens has a spherical component of the focus of greater than about 0.25 diopters, or less than about −0.25 diopters.

In some embodiments, the graded index lens, the first flexible film, the second flexible film, or any combination thereof has a Mohs hardness of about 4 to about 7. In some embodiments, the graded index lens, the first flexible film, the second flexible film, or any combination thereof has a Mohs hardness of about 4 to about 4.5, about 4 to about 5, about 4 to about 5.5, about 4 to about 6, about 4 to about 6.5, about 4 to about 7, about 4.5 to about 5, about 4.5 to about 5.5, about 4.5 to about 6, about 4.5 to about 6.5, about 4.5 to about 7, about 5 to about 5.5, about 5 to about 6, about 5 to about 6.5, about 5 to about 7, about 5.5 to about 6, about 5.5 to about 6.5, about 5.5 to about 7, about 6 to about 6.5, about 6 to about 7, or about 6.5 to about 7. In some embodiments, the graded index lens, the first flexible film, the second flexible film, or any combination thereof has a Mohs hardness of about 4, about 4.5, about 5, about 5.5, about 6, about 6.5, or about 7. In some embodiments, the graded index lens, the first flexible film, the second flexible film, or any combination thereof has a Mohs hardness of at least about 4, about 4.5, about 5, about 5.5, about 6, or about 6.5. In some embodiments, the graded index lens, the first flexible film, the second flexible film, or any combination thereof has a Mohs hardness of at most about 4.5, about 5, about 5.5, about 6, about 6.5, or about 7.

In some embodiments, the graded index lens, the first flexible film, the second flexible film, or any combination thereof has a Rockwell M hardness of about 50 to about 120. In some embodiments, the graded index lens, the first flexible film, the second flexible film, or any combination thereof has a Rockwell M hardness of about 50 to about 55, about 50 to about 60, about 50 to about 65, about 50 to about 70, about 50 to about 75, about 50 to about 80, about 50 to about 85, about 50 to about 90, about 50 to about 100, about 50 to about 110, about 50 to about 120, about 55 to about 60, about 55 to about 65, about 55 to about 70, about 55 to about 75, about 55 to about 80, about 55 to about 85, about 55 to about 90, about 55 to about 100, about 55 to about 110, about 55 to about 120, about 60 to about 65, about 60 to about 70, about 60 to about 75, about 60 to about 80, about 60 to about 85, about 60 to about 90, about 60 to about 100, about 60 to about 110, about 60 to about 120, about 65 to about 70, about 65 to about 75, about 65 to about 80, about 65 to about 85, about 65 to about 90, about 65 to about 100, about 65 to about 110, about 65 to about 120, about 70 to about 75, about 70 to about 80, about 70 to about 85, about 70 to about 90, about 70 to about 100, about 70 to about 110, about 70 to about 120, about 75 to about 80, about 75 to about 85, about 75 to about 90, about 75 to about 100, about 75 to about 110, about 75 to about 120, about 80 to about 85, about 80 to about 90, about 80 to about 100, about 80 to about 110, about 80 to about 120, about 85 to about 90, about 85 to about 100, about 85 to about 110, about 85 to about 120, about 90 to about 100, about 90 to about 110, about 90 to about 120, about 100 to about 110, about 100 to about 120, or about 110 to about 120. In some embodiments, the graded index lens, the first flexible film, the second flexible film, or any combination thereof has a Rockwell M hardness of about 50, about 55, about 60, about 65, about 70, about 75, about 80, about 85, about 90, about 100, about 110, or about 120. In some embodiments, the graded index lens, the first flexible film, the second flexible film, or any combination thereof has a Rockwell M hardness of at least about 50, about 55, about 60, about 65, about 70, about 75, about 80, about 85, about 90, about 100, or about 110. In some embodiments, the graded index lens, the first flexible film, the second flexible film, or any combination thereof has a Rockwell M hardness of at most about 55, about 60, about 65, about 70, about 75, about 80, about 85, about 90, about 100, about 110, or about 120.

In some embodiments, the graded index lens has a spherical component of the focus of about −0.25 D to about 0.25 D. In some embodiments, the graded index lens has a spherical component of the focus of about −0.25 D to about −0.2 D, about −0.25 D to about −0.15 D, about −0.25 D to about −0.1 D, about −0.25 D to about −0.05 D, about −0.25 D to about 0 D, about −0.25 D to about 0.05 D, about −0.25 D to about 0.1 D, about −0.25 D to about 0.15 D, about −0.25 D to about 0.2 D, about −0.25 D to about 0.25 D, about −0.2 D to about −0.15 D, about −0.2 D to about −0.1 D, about −0.2 D to about −0.05 D, about −0.2 D to about 0 D, about −0.2 D to about 0.05 D, about −0.2 D to about 0.1 D, about −0.2 D to about 0.15 D, about −0.2 D to about 0.2 D, about −0.2 D to about 0.25 D, about −0.15 D to about −0.1 D, about −0.15 D to about −0.05 D, about −0.15 D to about 0 D, about −0.15 D to about 0.05 D, about −0.15 D to about 0.1 D, about −0.15 D to about 0.15 D, about −0.15 D to about 0.2 D, about −0.15 D to about 0.25 D, about −0.1 D to about −0.05 D, about −0.1 D to about 0 D, about −0.1 D to about 0.05 D, about −0.1 D to about 0.1 D, about −0.1 D to about 0.15 D, about −0.1 D to about 0.2 D, about −0.1 D to about 0.25 D, about −0.05 D to about 0 D, about −0.05 D to about 0.05 D, about −0.05 D to about 0.1 D, about −0.05 D to about 0.15 D, about −0.05 D to about 0.2 D, about −0.05 D to about 0.25 D, about 0 D to about 0.05 D, about 0 D to about 0.1 D, about 0 D to about 0.15 D, about 0 D to about 0.2 D, about 0 D to about 0.25 D, about 0.05 D to about 0.1 D, about 0.05 D to about 0.15 D, about 0.05 D to about 0.2 D, about 0.05 D to about 0.25 D, about 0.1 D to about 0.15 D, about 0.1 D to about 0.2 D, about 0.1 D to about 0.25 D, about 0.15 D to about 0.2 D, about 0.15 D to about 0.25 D, or about 0.2 D to about 0.25 D, including increments therein. In some embodiments, the graded index lens has a spherical component of the focus of about −0.25 D, about −0.2 D, about −0.15 D, about −0.1 D, about −0.05 D, about 0 D, about 0.05 D, about 0.1 D, about 0.15 D, about 0.2 D, or about 0.25 D. In some embodiments, the graded index lens has a spherical component of the focus of at least about −0.25 D, about −0.2 D, about −0.15 D, about −0.1 D, about −0.05 D, about 0 D, about 0.05 D, about 0.1 D, about 0.15 D, or about 0.2 D. In some embodiments, the graded index lens has a spherical component of the focus of at most about −0.2 D, about −0.15 D, about −0.1 D, about −0.05 D, about 0 D, about 0.05 D, about 0.1 D, about 0.15 D, about 0.2 D, or about 0.25 D.

In some embodiments, the graded index lens further comprises an eyeglass frame coupling feature configured to couple to an eyeglass frame.

In some embodiments, a surface of the graded index lens is isometric to the first flexible film, the second flexible film, or both within about 1e-9% to about 10%. In some embodiments, a surface of the graded index lens is isometric to the first flexible film, the second flexible film, or both within about 1% to about 0.1%, about 1% to about 0.01%, about 1% to about 0.001%, about 1% to about 0.0001%, about 1% to about 0.00001%, about 1% to about 0.000001%, about 1% to about 1e-7%, about 1% to about 1e-8%, about 1% to about 1e-9%, about 1% to about 10%, about 0.1% to about 0.01%, about 0.1% to about 0.001%, about 0.1% to about 0.0001%, about 0.1% to about 0.00001%, about 0.1% to about 0.000001%, about 0.1% to about 1e-7%, about 0.1% to about 1e-8%, about 0.1% to about 1e-9%, about 0.1% to about 10%, about 0.01% to about 0.001%, about 0.01% to about 0.0001%, about 0.01% to about 0.00001%, about 0.01% to about 0.000001%, about 0.01% to about 1e-7%, about 0.01% to about 1e-8%, about 0.01% to about 1e-9%, about 0.01% to about 10%, about 0.001% to about 0.0001%, about 0.001% to about 0.00001%, about 0.001% to about 0.000001%, about 0.001% to about 1e-7%, about 0.001% to about 1e-8%, about 0.001% to about 1e-9%, about 0.001% to about 10%, about 0.0001% to about 0.00001%, about 0.0001% to about 0.000001%, about 0.0001% to about 1e-7%, about 0.0001% to about 1e-8%, about 0.0001% to about 1e-9%, about 0.0001% to about 10%, about 0.00001% to about 0.000001%, about 0.00001% to about 1e-7%, about 0.00001% to about 1e-8%, about 0.00001% to about 1e-9%, about 0.00001% to about 10%, about 0.000001% to about 1e-7%, about 0.000001% to about 1e-8%, about 0.000001% to about 1e-9%, about 0.000001% to about 10%, about 1e-7% to about 1e-8%, about 1e-7% to about 1e-9%, about 1e-7% to about 10%, about 1e-8% to about 1e-9%, about 1e-8% to about 10%, or about 1e-9% to about 10%, including increments therein. In some embodiments, a surface of the graded index lens is isometric to the flexible film within about 1%, about 0.1%, about 0.01%, about 0.001%, about 0.0001%, about 0.00001%, about 0.000001%, about 1e-7%, about 1e-8%, about 1e-9%, or about 10%. In some embodiments, a surface of the graded index lens is isometric to the first flexible film, the second flexible film, or both within at least about 1%, about 0.1%, about 0.01%, about 0.001%, about 0.0001%, about 0.00001%, about 0.000001%, about 1e-7%, about 1e-8%, or about 1e-9%. In some embodiments, a surface of the graded index lens is isometric to the first flexible film, the second flexible film, or both within at most about 0.1%, about 0.01%, about 0.001%, about 0.0001%, about 0.00001%, about 0.000001%, about 1e-7%, about 1e-8%, about 1e-9%, or about 10%.

In some embodiments, the method is not performed in clean room.

Another aspect provided herein is a method of forming a laminated graded index lens, the method comprising: coupling a first flexible film onto at least a portion of a primary surface of a graded index lens; and coupling a second flexible film onto at least a portion of a secondary surface of the graded index lens.

In some embodiments, the first flexible film, the second flexible film, or both comprise a polymer film, an anti-reflective film, a hard coat film, a hydrophobic film, a tint film, a polarizer film, a photochromatic film, a UV-blocking film or any combination thereof. In some embodiments, coupling the first flexible film, the second flexible film, or both onto the portion of the graded index lens comprises coupling the first flexible film, the second flexible film, or both by a roller. In some embodiments, the method comprises coupling two or more graded index lenses onto the at least a portion of the first flexible film simultaneously. In some embodiments, the method comprises coupling the second flexible film onto at least a portion of two or more graded index lenses simultaneously. In some embodiments, the graded index lens comprises a concave surface, a convex surface, or both. In some embodiments, the first flexible film, the second flexible film, or both are index matched to the graded index lens. In some embodiments, the first flexible film, the second flexible film, or both comprises a flexible glass film or a flexible polymer film. In some embodiments, first flexible film, the second flexible film, or both further comprises an anti-reflective film, a hydrophobic film, a hard coat film, an oleophobic film, a hydrophobic film, or any combination thereof, covering at least a portion of the flexible film, the graded index lens, or both. In some embodiments, the first flexible film, the second flexible film, or both comprise two or more of the anti-reflective film, a hydrophobic film, the hard coat film, the oleophobic film, the hydrophobic film, the tint film, the polarizer film, the photochromatic film, or the UV-blocking film. In some embodiments, the first flexible film, the second flexible film, or both comprise the flexible polymer film, and wherein the flexible polymer film comprises PET, PEN, transparent polyimide, polyimide, or any combination thereof.

In some embodiments, at least a portion of the flexible film covers a portion of the graded index lens of about 5% to about 90%. In some embodiments, at least a portion of the flexible film covers a portion of the graded index lens of about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 10% to about 20%, about 10% to about 30%, about 10% to about 40%, about 10% to about 50%, about 10% to about 60%, about 10% to about 70%, about 10% to about 80%, about 10% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%, including increments therein. In some embodiments, at least a portion of the flexible film covers a portion of the graded index lens of about 5%, about 10%, about 20%, about 30%, about 40%, about 50%, about 60%, about 70%, about 80%, or about 90%. In some embodiments, at least a portion of the flexible film covers a portion of the graded index lens of at least about 5%, about 10%, about 20%, about 30%, about 40%, about 50%, about 60%, about 70%, or about 80%. In some embodiments, at least a portion of the flexible film covers a portion of the graded index lens of at most about 10%, about 20%, about 30%, about 40%, about 50%, about 60%, about 70%, about 80%, or about 90%.

In some embodiments, at least a portion of the first flexible film, the second flexible film, or both is at least partially coupled to at least a portion of the graded index lens by an at least partially optically clear adhesive. In some embodiments, the graded index lens, the first flexible film, the second flexible film, or any combination thereof has a Mohs hardness of about 4 to about 7, a Rockwell M hardness of about 50 to about 120, or both. In some embodiments, the graded index lens has a spherical component of the focus of greater than about 0.25 diopters, or less than about −0.25 diopters.

In some embodiments, the graded index lens, the flexible film, or both has a Mohs hardness of about 4 to about 7. In some embodiments, the graded index lens, the flexible film, or both has a Mohs hardness of about 4 to about 4.5, about 4 to about 5, about 4 to about 5.5, about 4 to about 6, about 4 to about 6.5, about 4 to about 7, about 4.5 to about 5, about 4.5 to about 5.5, about 4.5 to about 6, about 4.5 to about 6.5, about 4.5 to about 7, about 5 to about 5.5, about 5 to about 6, about 5 to about 6.5, about 5 to about 7, about 5.5 to about 6, about 5.5 to about 6.5, about 5.5 to about 7, about 6 to about 6.5, about 6 to about 7, or about 6.5 to about 7. In some embodiments, the graded index lens, the flexible film, or both has a Mohs hardness of about 4, about 4.5, about 5, about 5.5, about 6, about 6.5, or about 7. In some embodiments, the graded index lens, the flexible film, or both has a Mohs hardness of at least about 4, about 4.5, about 5, about 5.5, about 6, or about 6.5. In some embodiments, the graded index lens, the flexible film, or both has a Mohs hardness of at most about 4.5, about 5, about 5.5, about 6, about 6.5, or about 7.

In some embodiments, the graded index lens, the flexible film, or both has a Rockwell M hardness of about 50 to about 120. In some embodiments, the graded index lens, the flexible film, or both has a Rockwell M hardness of about 50 to about 55, about 50 to about 60, about 50 to about 65, about 50 to about 70, about 50 to about 75, about 50 to about 80, about 50 to about 85, about 50 to about 90, about 50 to about 100, about 50 to about 110, about 50 to about 120, about 55 to about 60, about 55 to about 65, about 55 to about 70, about 55 to about 75, about 55 to about 80, about 55 to about 85, about 55 to about 90, about 55 to about 100, about 55 to about 110, about 55 to about 120, about 60 to about 65, about 60 to about 70, about 60 to about 75, about 60 to about 80, about 60 to about 85, about 60 to about 90, about 60 to about 100, about 60 to about 110, about 60 to about 120, about 65 to about 70, about 65 to about 75, about 65 to about 80, about 65 to about 85, about 65 to about 90, about 65 to about 100, about 65 to about 110, about 65 to about 120, about 70 to about 75, about 70 to about 80, about 70 to about 85, about 70 to about 90, about 70 to about 100, about 70 to about 110, about 70 to about 120, about 75 to about 80, about 75 to about 85, about 75 to about 90, about 75 to about 100, about 75 to about 110, about 75 to about 120, about 80 to about 85, about 80 to about 90, about 80 to about 100, about 80 to about 110, about 80 to about 120, about 85 to about 90, about 85 to about 100, about 85 to about 110, about 85 to about 120, about 90 to about 100, about 90 to about 110, about 90 to about 120, about 100 to about 110, about 100 to about 120, or about 110 to about 120. In some embodiments, the graded index lens, the flexible film, or both has a Rockwell M hardness of about 50, about 55, about 60, about 65, about 70, about 75, about 80, about 85, about 90, about 100, about 110, or about 120. In some embodiments, the graded index lens, the flexible film, or both has a Rockwell M hardness of at least about 50, about 55, about 60, about 65, about 70, about 75, about 80, about 85, about 90, about 100, or about 110. In some embodiments, the graded index lens, the flexible film, or both has a Rockwell M hardness of at most about 55, about 60, about 65, about 70, about 75, about 80, about 85, about 90, about 100, about 110, or about 120.

In some embodiments, the graded index lens has a spherical component of the focus of about −0.25 D to about 0.25 D. In some embodiments, the graded index lens has a spherical component of the focus of about −0.25 D to about −0.2 D, about −0.25 D to about −0.15 D, about −0.25 D to about −0.1 D, about −0.25 D to about −0.05 D, about −0.25 D to about 0 D, about −0.25 D to about 0.05 D, about −0.25 D to about 0.1 D, about −0.25 D to about 0.15 D, about −0.25 D to about 0.2 D, about −0.25 D to about 0.25 D, about −0.2 D to about −0.15 D, about −0.2 D to about −0.1 D, about −0.2 D to about −0.05 D, about −0.2 D to about 0 D, about −0.2 D to about 0.05 D, about −0.2 D to about 0.1 D, about −0.2 D to about 0.15 D, about −0.2 D to about 0.2 D, about −0.2 D to about 0.25 D, about −0.15 D to about −0.1 D, about −0.15 D to about −0.05 D, about −0.15 D to about 0 D, about −0.15 D to about 0.05 D, about −0.15 D to about 0.1 D, about −0.15 D to about 0.15 D, about −0.15 D to about 0.2 D, about −0.15 D to about 0.25 D, about −0.1 D to about −0.05 D, about −0.1 D to about 0 D, about −0.1 D to about 0.05 D, about −0.1 D to about 0.1 D, about −0.1 D to about 0.15 D, about −0.1 D to about 0.2 D, about −0.1 D to about 0.25 D, about −0.05 D to about 0 D, about −0.05 D to about 0.05 D, about −0.05 D to about 0.1 D, about −0.05 D to about 0.15 D, about −0.05 D to about 0.2 D, about −0.05 D to about 0.25 D, about 0 D to about 0.05 D, about 0 D to about 0.1 D, about 0 D to about 0.15 D, about 0 D to about 0.2 D, about 0 D to about 0.25 D, about 0.05 D to about 0.1 D, about 0.05 D to about 0.15 D, about 0.05 D to about 0.2 D, about 0.05 D to about 0.25 D, about 0.1 D to about 0.15 D, about 0.1 D to about 0.2 D, about 0.1 D to about 0.25 D, about 0.15 D to about 0.2 D, about 0.15 D to about 0.25 D, or about 0.2 D to about 0.25 D, including increments therein. In some embodiments, the graded index lens has a spherical component of the focus of about −0.25 D, about −0.2 D, about −0.15 D, about −0.1 D, about −0.05 D, about 0 D, about 0.05 D, about 0.1 D, about 0.15 D, about 0.2 D, or about 0.25 D. In some embodiments, the graded index lens has a spherical component of the focus of at least about −0.25 D, about −0.2 D, about −0.15 D, about −0.1 D, about −0.05 D, about 0 D, about 0.05 D, about 0.1 D, about 0.15 D, or about 0.2 D. In some embodiments, the graded index lens has a spherical component of the focus of at most about −0.2 D, about −0.15 D, about −0.1 D, about −0.05 D, about 0 D, about 0.05 D, about 0.1 D, about 0.15 D, about 0.2 D, or about 0.25 D.

In some embodiments, n the graded index lens further comprises an eyeglass frame coupling feature configured to couple to an eyeglass frame. In some embodiments, a surface of the graded index lens is isometric to the flexible film within about 1e-9% to about 10%. In some embodiments, a surface of the graded index lens is isometric to the flexible film within about 1% to about 0.1%, about 1% to about 0.01%, about 1% to about 0.001%, about 1% to about 0.0001%, about 1% to about 0.00001%, about 1% to about 0.000001%, about 1% to about 1e-7%, about 1% to about 1e-8%, about 1% to about 1e-9%, about 1% to about 10%, about 0.1% to about 0.01%, about 0.1% to about 0.001%, about 0.1% to about 0.0001%, about 0.1% to about 0.00001%, about 0.1% to about 0.000001%, about 0.1% to about 1e-7%, about 0.1% to about 1e-8%, about 0.1% to about 1e-9%, about 0.1% to about 10%, about 0.01% to about 0.001%, about 0.01% to about 0.0001%, about 0.01% to about 0.00001%, about 0.01% to about 0.000001%, about 0.01% to about 1e-7%, about 0.01% to about 1e-8%, about 0.01% to about 1e-9%, about 0.01% to about 10%, about 0.001% to about 0.0001%, about 0.001% to about 0.00001%, about 0.001% to about 0.000001%, about 0.001% to about 1e-7%, about 0.001% to about 1e-8%, about 0.001% to about 1e-9%, about 0.001% to about 10%, about 0.0001% to about 0.00001%, about 0.0001% to about 0.000001%, about 0.0001% to about 1e-7%, about 0.0001% to about 1e-8%, about 0.0001% to about 1e-9%, about 0.0001% to about 10%, about 0.00001% to about 0.000001%, about 0.00001% to about 1e-7%, about 0.00001% to about 1e-8%, about 0.00001% to about 1e-9%, about 0.00001% to about 10%, about 0.000001% to about 1e-7%, about 0.000001% to about 1e-8%, about 0.000001% to about 1e-9%, about 0.000001% to about 10%, about 1e-7% to about 1e-8%, about 1e-7% to about 1e-9%, about 1e-7% to about 10%, about 1e-8% to about 1e-9%, about 1e-8% to about 10%, or about 1e-9% to about 10%, including increments therein. In some embodiments, a surface of the graded index lens is isometric to the flexible film within about 1%, about 0.1%, about 0.01%, about 0.001%, about 0.0001%, about 0.00001%, about 0.000001%, about 1e-7%, about 1e-8%, about 1e-9%, or about 10%. In some embodiments, a surface of the graded index lens is isometric to the flexible film within at least about 1%, about 0.1%, about 0.01%, about 0.001%, about 0.0001%, about 0.00001%, about 0.000001%, about 1e-7%, about 1e-8%, or about 1e-9%. In some embodiments, a surface of the graded index lens is isometric to the flexible film within at most about 0.1%, about 0.01%, about 0.001%, about 0.0001%, about 0.00001%, about 0.000001%, about 1e-7%, about 1e-8%, about 1e-9%, or about 10%.

In some embodiments, the method is not performed in clean room.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an illustration of a first exemplary laminated graded index lens, per an embodiment herein;

FIG. 2 shows an illustration of a second exemplary laminated graded index lens, per an embodiment herein;

FIG. 3 shows an illustration of a third exemplary laminated graded index lens, per an embodiment herein;

FIG. 4 shows an illustration of a fourth exemplary laminated graded index lens, per an embodiment herein;

FIG. 5 shows an illustration of a fifth exemplary laminated graded index lens, per an embodiment herein;

FIG. 6 shows an illustration of a sixth exemplary laminated graded index lens, per an embodiment herein;

FIG. 7A shows an illustration of a first cross-sectional shape of an exemplary graded index lens, per an embodiment herein;

FIG. 7B shows an illustration of a second cross-sectional shape of an exemplary graded index lens, per an embodiment herein;

FIG. 8A shows an illustration of a third cross-sectional shape of an exemplary graded index lens, per an embodiment herein;

FIG. 8B shows an illustration of a fourth cross-sectional shape of an exemplary graded index lens, per an embodiment herein;

FIG. 9 shows a flowchart of an exemplary method of forming a laminated graded index lens; per an embodiment herein;

FIG. 10 shows a flowchart of an exemplary method of printing a laminated graded index lens; per an embodiment herein;

FIG. 11 shows an illustration of an exemplary method of coating a laminated graded index lens; per an embodiment herein;

FIG. 12 shows an illustration of coupling a flexible film to the laminated graded index lens by a roller; and

FIG. 13 shows a perspective illustration of a fifth exemplary graded index lens, per an embodiment herein.

### DETAILED DESCRIPTION

Some lenses are formed of a transparent or translucent material having a homogeneous refractive index, which focuses light impinging thereon through surface geometries having one or two dimensions of curvature. Graded index (GRIN) lenses, however, employ heterogeneous refractive indices to focus light through both the refractive index distribution and the surface geometries of the graded index lens. However, the surface geometry of a lens, in many cases is bound by the conditions of its use, independent of its optical properties. For example, eyeglass lenses need to fit in eyeglass frames. As the shape of eyeglass frames are determined by fashion trends and the shape of the wearer's face, such lenses often have a convex distal surface and a concave proximal surface

Some such lenses are coated with one or more layers to improve their optical properties. To coat every curved surface, either a vacuum deposition process or a liquid precursor is often required, followed by several individual coating operations. As the specific curvatures of many homogeneous lenses must be individually formed before coating, such coating processes often require the use of a mounting stage that is uniquely configured for each lens size and geometry. Further, the process and machinery used to apply such coatings consistently over surfaces of various curvatures while preventing contaminants from becoming embedded therein are often costly and prone to defects. Consistently applying consecutive layers of hard and flexible coatings further complicates such processes and equipment.

Commercially available flexible films are useful for optical systems and can include anti-reflective coatings, hard coats, and hydrophobic, and oleophobic surfaces. These films can be applied to large uniform sheets at low cost and high quality. Such films, however, when used with current lenses may not achieve both optimal focus and a shape amenable to being coated with a film. These films can be bent to cover surfaces that bend in one dimension. The films are able to simultaneously bend in a second dimension but only to a much more limited degree. In some embodiments, the flexible films can be bent to cover a graded index lens having surface that is curved in one dimension without stretching, whereas distances measured along the surface (intrinsic) are unchanged. In some embodiments, a graded index lens having a surface that is curved in two dimensions may stretch to fit the contour of the surface of the graded index lens.

For many applications, it is desirable to have optics that are compact and lightweight with lenses that are thin. For uses in eyeglasses thin and light are especially important because they relate to comfort and aesthetics. For current technology the minimum weight and thickness that can be achieved for eyeglass lenses is related to the strength of the prescription required and to the requirements for impact resistance. Using laminated graded index lenses allows for thinner lenses to be able to withstand the required impact.

### Laminated Graded Index Lenses

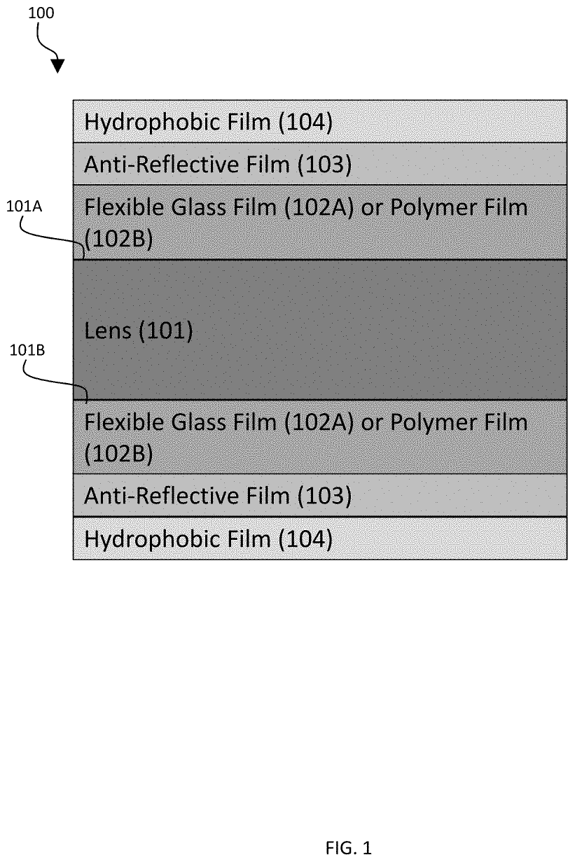

Provided herein, per FIGS. 1-8 and 13, are graded index lenses 100. In some embodiments, the graded index lens 100 comprises a graded index lens 101 with a graded index pattern and a flexible film coupled to at least a portion of the laminated graded index lens 100. In some embodiments, the laminated graded index lens 100 has a primary surface 101A and a secondary surface 101B.

FIG. 1 shows an illustration of a first exemplary laminated graded index lens 100 comprises a graded index lens 101 having a primary surface 101A and a secondary surface 101B, one flexible glass film 102A or polymer film 102B coupled to the primary surface 101A of the graded index lens 101, and one flexible glass film 102A or polymer film 102B coupled to the secondary surface 101B of the graded index lens 101. Further as shown, each flexible glass film 102A or polymer film 102B is covered by an anti-reflective film 103, and each anti-reflective film 103 is covered by a hydrophobic film 104. In some embodiments, the primary surface 101A or the secondary surface 101B are not covered with the film 102A 102B 103 104. In some embodiments, only one of the primary surface 101A and the secondary surface 101B is covered with the film 102A 102B 103 104.

In some embodiments, at least a portion of the flexible film is coupled to at least a portion of the primary surface 101A of the graded index lens 101, the secondary surface 101B of the graded index lens 101, or both. In some embodiments, at least a portion of the flexible film is coupled to at least a portion of the primary surface 101A of the graded index lens 101, at least a portion of the secondary surface 101B of the graded index lens 101, or both. In some embodiments, at least a portion of the flexible film comprises a first flexible film and a second flexible film. In some embodiments, at least a portion of the first flexible film is coupled to at least a portion of the primary surface 101A of the graded index lens 101, at least a portion of the secondary surface 101B of the graded index lens 101, or both. In some embodiments, at least a portion of the second flexible film is coupled to at least a portion of the primary surface 101A of the graded index lens 101, at least a portion of the secondary surface 101B of the graded index lens 101, or both. In some embodiments, at least a portion of the flexible film comprises two or more layers of the flexible film. In some embodiments, at least a portion of the first flexible film, at least a portion of the second flexible film, or both comprise two or more layers of the flexible film. In some embodiments, at least a portion of two or more layers of film are at least partially coupled by an at least optically clear adhesive 105. In some embodiments, the at least optically clear adhesive 105 is transparent. In some embodiments, the at least optically clear adhesive 105 is translucent. In some embodiments, the at least optically clear adhesive 105 is tinted. In some embodiments, the at least optically clear adhesive 105 is transparent. In some embodiments, the at least optically clear adhesive 105 comprises a drying adhesive, a pressure sensitive adhesive, a contact adhesive, a hot adhesive, a reactive adhesive, an anaerobic adhesive, a multi-part adhesive, a one-part adhesive, a natural adhesive, a synthetic adhesive, a tape, a gel, a liquid, a film, or any combination thereof. In some embodiments, the at least optically clear adhesive 105 is sufficiently strong to couple the flexible film to the graded index lens 101 through wear and use in an eyeglass frame.

In some embodiments, at least a portion of the flexible film is coupled to about 5%, 10%, 15%, 20%, 25%, 30%, 35%, 40%, 45%, 50%, 60%, 70%, 80%, 90%, or more of the primary surface 101A. In some embodiments, at least a portion of the flexible film is coupled to about 5%, 10%, 15%, 20%, 25%, 30%, 35%, 40%, 45%, 50%, 60%, 70%, 80%, 90%, or more of the secondary surface 101B. In some embodiments, about 5%, 10%, 15%, 20%, 25%, 30%, 35%, 40%, 45%, 50%, 60%, 70%, 80%, 90%, or more of the flexible film is coupled to the primary surface 101A. In some embodiments, about 5%, 10%, 15%, 20%, 25%, 30%, 35%, 40%, 45%, 50%, 60%, 70%, 80%, 90%, or more of the flexible film is coupled to the secondary surface 101B.

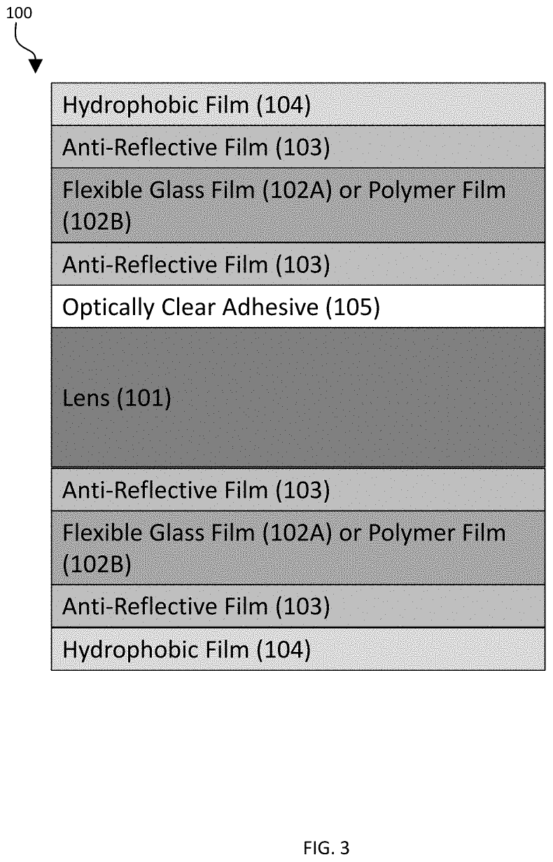

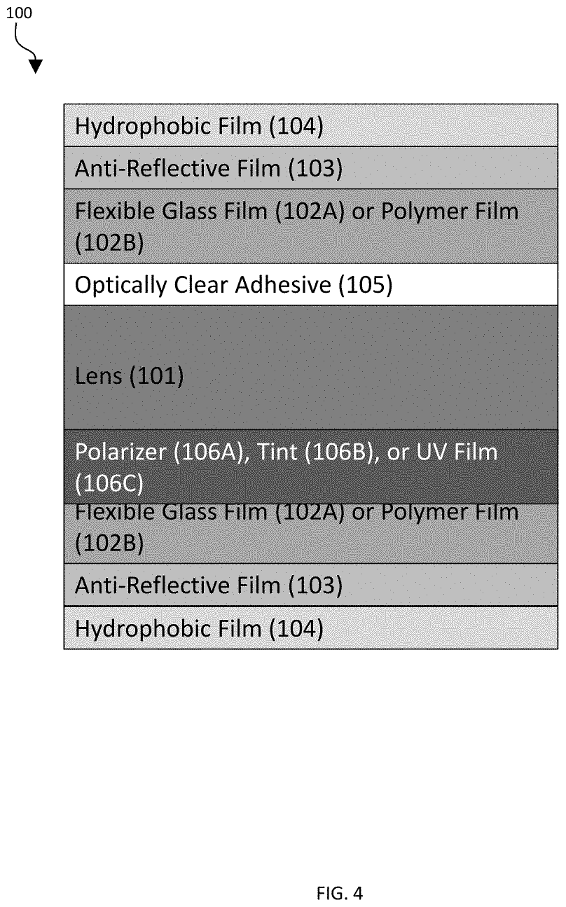

In some embodiments, the flexible film comprises, a flexible polymer film 102B, a flexible glass film 102A, an anti-reflective film 103, a hydrophobic film 104, a tint film 106B, a polarizer film 106A, a photochromatic film, a UV-blocking film 106C, or any combination thereof. In some embodiments, the flexible film comprises two or more layers of the flexible polymer film 102B, the flexible glass film 102A, the anti-reflective film 103, the hydrophobic film 104, the tint film 106B, the polarizer film 106A, the photochromatic film, the UV-blocking film 106C, or any combination thereof. Per FIG. 3, in some embodiments, both sides of the flexible glass film 102A or polymer film 102B are coated with the anti-reflective film 103. Per FIG. 4, in some embodiments, the polarizer film 106A, the tint film 106B, the UV-blocking film 106C, or any combination thereof are coupled to the secondary surface 101B of the graded index lens 101, wherein the flexible glass film 102A or polymer film 102B is further coupled to the flexible glass film 102A or polymer film 102B.

In some embodiments, the flexible film comprises the flexible polymer film 102B, the flexible glass film 102A, the anti-reflective film 103, the hydrophobic film 104, the oleophobic coating, the tint film 106B, the polarizer film 106A, the photochromatic film, the UV-blocking film 106C, or any combination thereof on at least a portion of the outer surface of the flexible film distal to at least a portion of the graded index lens 101. In some embodiments, the flexible film comprises the anti-reflective film 103, the hydrophobic film 104, the oleophobic coating, the tint film 106B, the polarizer film 106A, the photochromatic film, the UV-blocking film 106C, or any combination thereof on at least a portion of the inner surface of the flexible film mesial to at least a portion of the graded index lens 101. One of skill in the art would immediately recognize that flexible glass film 102A may be a customized flexible glass film 102A, or a commercially available flexible glass film 102A, from a vendor (e.g. Schott, or Corning).

In some embodiments, when the flexible film 102A 102B 103 104, covers the graded index lens 101, a width, length, thickness, or any combination thereof of the flexible film 102A 102B 103 104 increases or decreases by at most about 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%, 0.0009%, 0.0008%, 0.0007%, 0.0006%, 0.0005%, 0.0004%, 0.0003%, 0.0002%, 0.0001%, 0.000009%, 0.000008%, 0.000007%, 0.000006%, 0.000005%, 0.000004%, 0.000003%, 0.000002%, 0.000001%, 0.0000009%, 0.0000008%, 0.0000007%, 0.0000006%, 0.0000005%, 0.0000004%, 0.0000003%, 0.0000002%, 0.0000001%, 0.00000009%, 0.00000008%, 0.00000007%, 0.00000006%, 0.00000005%, 0.00000004%, 0.00000003%, 0.00000002%, 0.00000001%, 0.000000009%, 0.000000008%, 0.000000007%, 0.000000006%, 0.000000005%, 0.000000004%, 0.000000003%, 0.000000002%, or 0.000000001%. In some embodiments, at least a portion of the primary surface, at least a portion of the secondary surface, or both are not substantially curved in the second dimension. In some embodiments, at least a portion of the flexible film 102A 102B 103 104 is deformable. In some embodiments, at least a portion of the flexible film 102A 102B 103 104 is elastic. In some embodiments, at least a portion of the flexible film 102A 102B 103 104 is a thermoplastic.

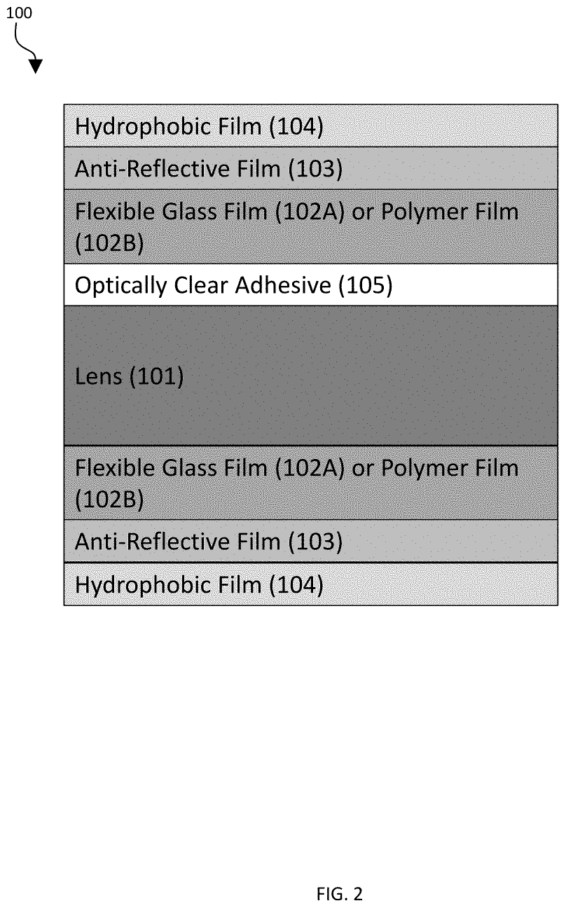

In some embodiments, the polymer comprises PET, PEN, transparent polyimide, polyimide, or any combination thereof. In some embodiments, at least a portion of the flexible film is index matched to the graded index lens 101. In some embodiments, at least a portion of the flexible polymer film 102B is index matched to the graded index lens 101. In some embodiments, at least a portion of the flexible glass film 102A is index matched to the graded index lens 101. Per FIG. 2, in some embodiments, the flexible glass film 102A or polymer film 102B is coupled to the primary surface 101A of the graded index lens 101 by an at least partially optically clear adhesive 105. In some embodiments, at least a portion of the flexible film is coupled to the graded index lens 101 by an at least partially optically clear adhesive 105. In some embodiments, at least a portion of the first flexible film is coupled to the graded index lens 101 by the at least partially optically clear adhesive 105. In some embodiments, at least a portion of the second flexible film is coupled to the graded index lens 101 by the at least partially optically clear adhesive 105. In some embodiments, the graded lens is directly printed onto the flexible film. In some embodiments, the graded lens is directly printed onto the first flexible film. In some embodiments, the graded lens is directly printed onto the second flexible film.

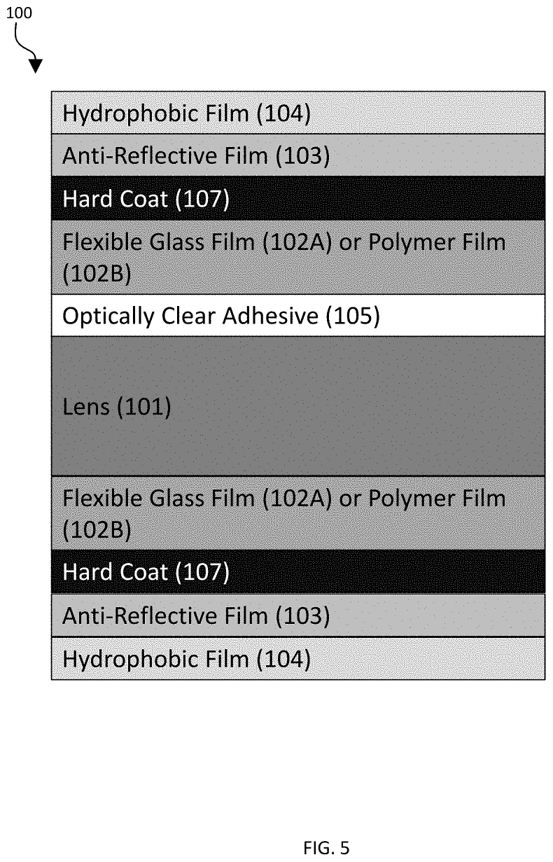

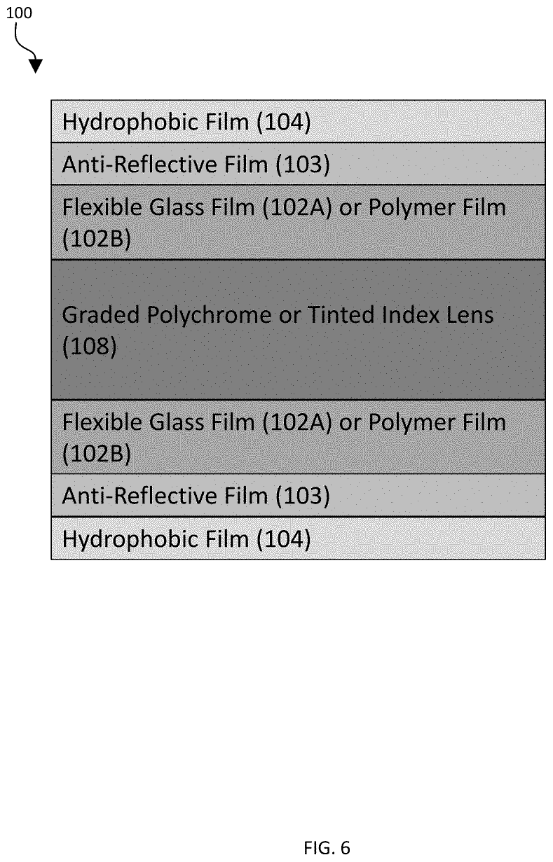

In some embodiments, at least a portion of the anti-reflective film 103, the hydrophobic film 104, the tint film 106B, the polarizer film 106A, the photochromatic film, the UV-blocking film 106C, or any combination thereof comprise an oleophobic coating. In some embodiments, at least a portion of the anti-reflective film 103, the hydrophobic film 104, the tint film 106B, the polarizer film 106A, the photochromatic film, the UV-blocking film 106C, or any combination thereof comprise a hard coat 108. Per FIG. 5, in some embodiments, a distal surface of each flexible glass film 102A or polymer film 102B comprises the hard coat 108. In some embodiments, the hard coat 108 protects the graded index lens 101 from scratches. In some embodiments, the combination of the hard coat 108 and the flexible film increases the strength, impact resistance, or both of the graded index lens 101. In some embodiments, the oleophobic coating improves the graded index lens' 101 ability to stay clean. In some embodiments, the polarizer film 106A comprises a photochromic film. In some embodiments, per FIG. 6, the graded index lens 101 comprises a graded polychrome or tinted index lens 100.

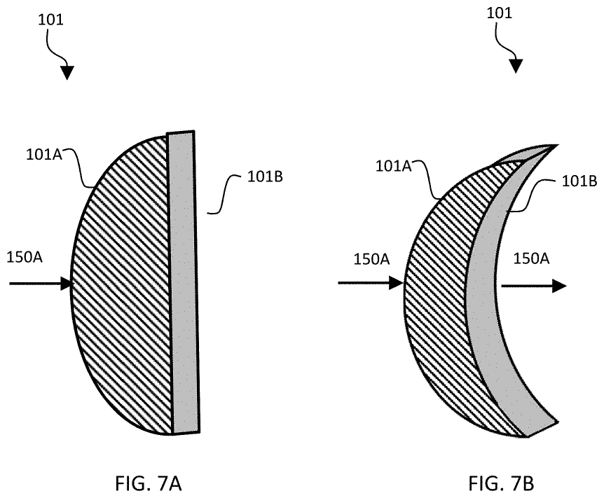

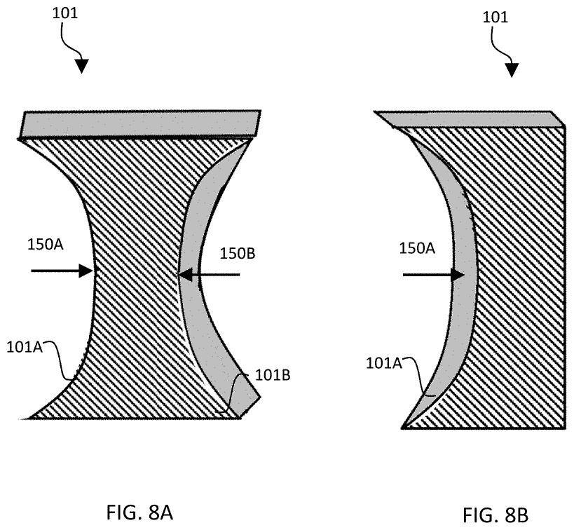

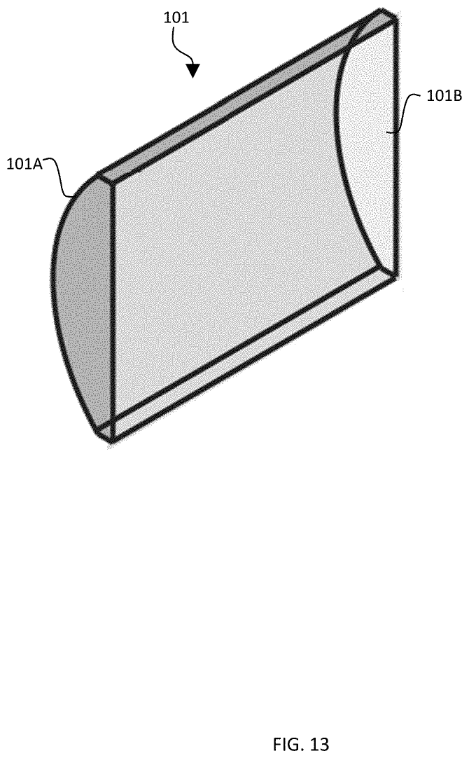

FIGS. 7A-8B show cross-sectional views of exemplary graded index lenses 101. As shown, the hashed/dashed areas indicate interior regions of the graded index lenses 101 that are cut by the cross-sectional view and solid surface represent outer surfaces of the graded index lenses 101. In some embodiments, at least a portion of the primary surface 101A, at least a portion of the secondary surface 101B, or both, are curved. In some embodiments, at least a portion of the primary surface 101A, at least a portion of the secondary surface 101B, or both are curved in a first dimension. Per FIGS. 7A-7D, in some embodiments, at least a portion of the primary surface 101A, at least a portion of the secondary surface 101B, or both are curved only in the first dimension. Further, per FIGS. 7A and 7D, in some embodiments, at least a portion of the primary surface 101A, at least a portion of the secondary surface 101B, or both are flat. In some embodiments, per the cross sections shown in FIGS. 8A and 8B, at least a portion of the primary surface 101A, at least a portion of the secondary surface 101B, or both are curved in the first dimension and in a second dimension perpendicular to the first dimension. In some embodiments, the curvature of at least a portion of the primary surface 101A and the secondary surface 101B in the first dimension are in the same direction. In some embodiments, the curvature of at least a portion of the primary surface 101A and the secondary surface 101B in the first dimension are in opposite directions. In some embodiments, the curvature of at least a portion of the primary surface 101A and at least a portion of the secondary surface 101B in the second dimension are in the same direction. In some embodiments, the curvature of at least a portion of the primary surface 101A and at least a portion of the secondary surface 101B in the second dimension are in opposite directions. In some embodiments, at least a portion of the graded index lens 101 has a concave surface, a convex surface, or both. Per FIGS. 7A and 13, in some embodiments, the primary surface 101A of the graded index lens 101 is convexly curved in the first direction 150A and the secondary surface 101B is flat. Per FIG. 7B, in some embodiments, the primary surface 101A of the graded index lens 101 is convexly curved in the first direction 150A and the secondary surface 101B is concavely curved in the first direction 150A. Per FIG. 8A, in some embodiments, the primary surface 101A of the graded index lens 101 is concavely curved in the first direction 150A and the secondary surface 101B is concavely curved in a second direction 150A opposite the first direction 150A. Per FIG. 8B, in some embodiments, the primary surface 101A of the graded index lens 101 is concavely curved in the first direction 150A and the secondary surface 101B is flat. In some embodiments, the flexible film is coupled to the graded index lens 101 by an at least partially optically clear adhesive. In some embodiments, the graded lens is directly printed onto the flexible film. In some embodiments, at least a portion of the primary surface 101A, at least a portion of the secondary surface 101B, or both are not substantially curved in the second dimension.

In some embodiments, the primary surface 101A of the graded index lens 101 is convexly curved in the first dimension (shown as a left to right dimension) and convexly curved in the second dimension (shown as a dimension into the plane of the paper), wherein the secondary surface 101B is concavely curved in the first dimension and concavely curved in the second dimension. In some embodiments, the primary surface 101A of the graded index lens 101 is convexly curved in the first dimension and concavely curved in the second dimension, wherein the secondary surface 101B is concavely curved in the first dimension and convexly curved in the second dimension.

In some embodiments, at least a portion of the local curvature of the primary surface 101A, the secondary surface, 101B, or both in the second dimension has a radius of at least about 1,000 m, 900 m, 800 m, 700 m, 600 m, 500 m, 400 m, 300 m, 200 m, 100 m, 50 m, 25 m, 10 m, 9 m, 8 m, 7 m, 6 m, 5 m, 4 m, 3 m, 2 m, 1 m, or 0.5 m. In some embodiments, at least a portion of the curvature of the primary surface 101A, the secondary surface, 101B, or both in the first dimension has a radius of about 0.5 m to about 500 m. In some embodiments, at least a portion of the local curvature of the primary surface 101A, the secondary surface, 101B, or both in the first dimension has a radius of about 0.5 m to about 1 m, about 0.5 m to about 5 m, about 0.5 m to about 10 m, about 0.5 m to about 25 m, about 0.5 m to about 50 m, about 0.5 m to about 100 m, about 0.5 m to about 250 m, about 0.5 m to about 500 m, about 1 m to about 5 m, about 1 m to about 10 m, about 1 m to about 25 m, about 1 m to about 50 m, about 1 m to about 100 m, about 1 m to about 250 m, about 1 m to about 500 m, about 5 m to about 10 m, about 5 m to about 25 m, about 5 m to about 50 m, about 5 m to about 100 m, about 5 m to about 250 m, about 5 m to about 500 m, about 10 m to about 25 m, about 10 m to about 50 m, about 10 m to about 100 m, about 10 m to about 250 m, about 10 m to about 500 m, about 25 m to about 50 m, about 25 m to about 100 m, about 25 m to about 250 m, about 25 m to about 500 m, about 50 m to about 100 m, about 50 m to about 250 m, about 50 m to about 500 m, about 100 m to about 250 m, about 100 m to about 500 m, or about 250 m to about 500 m, including increments therein. In some embodiments, at least a portion of the local curvature of the primary surface 101A, the secondary surface, 101B, or both in the first dimension has a radius of about 0.5 m, about 1 m, about 5 m, about 10 m, about 25 m, about 50 m, about 100 m, about 250 m, or about 500 m. In some embodiments, at least a portion of the local curvature of the primary surface 101A, the secondary surface, 101B, or both in the first dimension has a radius of at least about 0.5 m, about 1 m, about 5 m, about 10 m, about 25 m, about 50 m, about 100 m, or about 250 m. In some embodiments, at least a portion of the local curvature of the primary surface 101A, the secondary surface, 101B, or both in the first dimension has a radius of at most about 1 m, about 5 m, about 10 m, about 25 m, about 50 m, about 100 m, about 250 m, or about 500 m. In some embodiments, at least a portion of the local curvature of the primary surface 101A, the secondary surface, 101B, or both in the second dimension has a radius of about 0.5 m to about 500 m. In some embodiments, at least a portion of the local curvature of the primary surface 101A, the secondary surface, 101B, or both in the second dimension has a radius of about 0.5 m to about 1 m, about 0.5 m to about 5 m, about 0.5 m to about 10 m, about 0.5 m to about 25 m, about 0.5 m to about 50 m, about 0.5 m to about 100 m, about 0.5 m to about 250 m, about 0.5 m to about 500 m, about 1 m to about 5 m, about 1 m to about 10 m, about 1 m to about 25 m, about 1 m to about 50 m, about 1 m to about 100 m, about 1 m to about 250 m, about 1 m to about 500 m, about 5 m to about 10 m, about 5 m to about 25 m, about 5 m to about 50 m, about 5 m to about 100 m, about 5 m to about 250 m, about 5 m to about 500 m, about 10 m to about 25 m, about 10 m to about 50 m, about 10 m to about 100 m, about 10 m to about 250 m, about 10 m to about 500 m, about 25 m to about 50 m, about 25 m to about 100 m, about 25 m to about 250 m, about 25 m to about 500 m, about 50 m to about 100 m, about 50 m to about 250 m, about 50 m to about 500 m, about 100 m to about 250 m, about 100 m to about 500 m, or about 250 m to about 500 m, including increments therein. In some embodiments, at least a portion of the curvature of the primary surface 101A, the secondary surface, 101B, or both in the second dimension has a radius of about 0.5 m, about 1 m, about 5 m, about 10 m, about 25 m, about 50 m, about 100 m, about 250 m, or about 500 m. In some embodiments, at least a portion of the curvature of the primary surface 101A, the secondary surface, 101B, or both in the second dimension has a radius of at least about 0.5 m, about 1 m, about 5 m, about 10 m, about 25 m, about 50 m, about 100 m, or about 250 m. In some embodiments, at least a portion of the curvature of the primary surface 101A, the secondary surface, 101B, or both in the second dimension has a radius of at most about 1 m, about 5 m, about 10 m, about 25 m, about 50 m, about 100 m, about 250 m, or about 500 m.

In some embodiments, the curvature of the primary surface 101A, the secondary surface, 101B, or both in the first dimension is greater than the curvature of the primary surface 101A, the secondary surface, 101B, or both in the second dimension. In some embodiments, the curvature of the primary surface 101A, the secondary surface, 101B, or both in the first dimension being greater than the curvature of the primary surface 101A, the secondary surface, 101B, or both in the second dimension reduces wrinkling, deformation, or both, of the flexible film applied to the primary surface or the secondary surface. In some embodiments, the curvature of the primary surface 101A, the secondary surface, 101B, or both in the first dimension is less than the curvature of the primary surface 101A, the secondary surface, 101B, or both in the second dimension. In some embodiments, a ratio between at least a portion of the curvature of the primary surface 101A, at least a portion of the secondary surface, 101B or both in the first dimension and at least a portion of the curvature of the primary surface 101A, the secondary surface, 101B, or both in the second dimension is about 1:1 to about 50:1. In some embodiments, a ratio between at least a portion of the curvature of the primary surface 101A, the secondary surface, 101B, or both in the first dimension and at least a portion of the curvature of the primary surface 101A, the secondary surface, 101B, or both in the second dimension is about 1:1 to about 2:1, about 1:1 to about 3:1, about 1:1 to about 4:1, about 1:1 to about 5:1, about 1:1 to about 10:1, about 1:1 to about 15:1, about 1:1 to about 20:1, about 1:1 to about 25:1, about 1:1 to about 40:1, about 1:1 to about 50:1, about 2:1 to about 3:1, about 2:1 to about 4:1, about 2:1 to about 5:1, about 2:1 to about 10:1, about 2:1 to about 15:1, about 2:1 to about 20:1, about 2:1 to about 25:1, about 2:1 to about 40:1, about 2:1 to about 50:1, about 3:1 to about 4:1, about 3:1 to about 5:1, about 3:1 to about 10:1, about 3:1 to about 15:1, about 3:1 to about 20:1, about 3:1 to about 25:1, about 3:1 to about 40:1, about 3:1 to about 50:1, about 4:1 to about 5:1, about 4:1 to about 10:1, about 4:1 to about 15:1, about 4:1 to about 20:1, about 4:1 to about 25:1, about 4:1 to about 40:1, about 4:1 to about 50:1, about 5:1 to about 10:1, about 5:1 to about 15:1, about 5:1 to about 20:1, about 5:1 to about 25:1, about 5:1 to about 40:1, about 5:1 to about 50:1, about 10:1 to about 15:1, about 10:1 to about 20:1, about 10:1 to about 25:1, about 10:1 to about 40:1, about 10:1 to about 50:1, about 15:1 to about 20:1, about 15:1 to about 25:1, about 15:1 to about 40:1, about 15:1 to about 50:1, about 20:1 to about 25:1, about 20:1 to about 40:1, about 20:1 to about 50:1, about 25:1 to about 40:1, about 25:1 to about 50:1, or about 40:1 to about 50:1, including increments therein. In some embodiments, a ratio between at least a portion of the curvature of the primary surface 101A, the secondary surface, 101B, or both in the first dimension and at least a portion of the curvature of the primary surface 101A, the secondary surface, 101B, or both in the second dimension is about 1:1, about 2:1, about 3:1, about 4:1, about 5:1, about 10:1, about 15:1, about 20:1, about 25:1, about 40:1, or about 50:1. In some embodiments, a ratio between at least a portion of the curvature of the primary surface 101A, the secondary surface, 101B, or both in the first dimension and at least a portion of the curvature of the primary surface 101A, the secondary surface, 101B, or both in the second dimension is at least about 1:1, about 2:1, about 3:1, about 4:1, about 5:1, about 10:1, about 15:1, about 20:1, about 25:1, or about 40:1. In some embodiments, a ratio between at least a portion of the curvature of the primary surface 101A, the secondary surface, 101B, or both in the first dimension and at least a portion of the curvature of the primary surface 101A, the secondary surface, 101B, or both in the second dimension is at most about 2:1, about 3:1, about 4:1, about 5:1, about 10:1, about 15:1, about 20:1, about 25:1, about 40:1, or about 50:1.

In some embodiments the primary surface 101A, the secondary surface, 101B, or both of the graded index lens 101, is isometric to at least a portion of the flexible film. In some embodiments the primary surface 101A, the secondary surface, 101B, or both of the graded index lens 101 is isometric to at least a portion of the flexible film within at least about 10% 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%, 0.0009%, 0.0008%, 0.0007%, 0.0006%, 0.0005%, 0.0004%, 0.0003%, 0.0002%, 0.0001%, 0.000009%, 0.000008%, 0.000007%, 0.000006%, 0.000005%, 0.000004%, 0.000003%, 0.000002%, 0.000001%, 0.0000009%, 0.0000008%, 0.0000007%, 0.0000006%, 0.0000005%, 0.0000004%, 0.0000003%, 0.0000002%, 0.0000001%, 0.00000009%, 0.00000008%, 0.00000007%, 0.00000006%, 0.00000005%, 0.00000004%, 0.00000003%, 0.00000002%, 0.00000001%, 0.000000009%, 0.000000008%, 0.000000007%, 0.000000006%, 0.000000005%, 0.000000004%, 0.000000003%, 0.000000002%, or 0.000000001%. In some embodiments, at least a portion of the primary surface 101A, at least a portion of the secondary surface 101B, or both are not substantially curved in the second dimension. In some embodiments, the radius of curvature in the one or more dimensions is not substantially constant across the graded index lens 101.

In some embodiments about 5%, 10%, 15%, 20%, 25%, 30%, 35%, 40%, 45%, 50%, 60%, 70%, 80%, 90%, or more of the primary surface 101A is isometric to at least a portion of the flexible film within at least about 10% 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%, 0.0009%, 0.0008%, 0.0007%, 0.0006%, 0.0005%, 0.0004%, 0.0003%, 0.0002%, 0.0001%, 0.000009%, 0.000008%, 0.000007%, 0.000006%, 0.000005%, 0.000004%, 0.000003%, 0.000002%, 0.000001%, 0.0000009%, 0.0000008%, 0.0000007%, 0.0000006%, 0.0000005%, 0.0000004%, 0.0000003%, 0.0000002%, 0.0000001%, 0.00000009%, 0.00000008%, 0.00000007%, 0.00000006%, 0.00000005%, 0.00000004%, 0.00000003%, 0.00000002%, 0.00000001%, 0.000000009%, 0.000000008%, 0.000000007%, 0.000000006%, 0.000000005%, 0.000000004%, 0.000000003%, 0.000000002%, or 0.000000001%. In some embodiments about 5%, 10%, 15%, 20%, 25%, 30%, 35%, 40%, 45%, 50%, 60%, 70%, 80%, 90%, or more of the secondary surface 101B, including increments therein, is isometric to at least a portion of the flexible film within at least about 10% 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%, 0.0009%, 0.0008%, 0.0007%, 0.0006%, 0.0005%, 0.0004%, 0.0003%, 0.0002%, 0.0001%, 0.000009%, 0.000008%, 0.000007%, 0.000006%, 0.000005%, 0.000004%, 0.000003%, 0.000002%, 0.000001%, 0.0000009%, 0.0000008%, 0.0000007%, 0.0000006%, 0.0000005%, 0.0000004%, 0.0000003%, 0.0000002%, 0.0000001%, 0.00000009%, 0.00000008%, 0.00000007%, 0.00000006%, 0.00000005%, 0.00000004%, 0.00000003%, 0.00000002%, 0.00000001%, 0.000000009%, 0.000000008%, 0.000000007%, 0.000000006%, 0.000000005%, 0.000000004%, 0.000000003%, 0.000000002%, or 0.000000001%, including increments therein.

In some embodiments about 5%, 10%, 15%, 20%, 25%, 30%, 35%, 40%, 45%, 50%, 60%, 70%, 80%, 90%, or more of the primary surface 101A is isometric to at most a portion of the flexible film within at most about 10% 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%, 0.0009%, 0.0008%, 0.0007%, 0.0006%, 0.0005%, 0.0004%, 0.0003%, 0.0002%, 0.0001%, 0.000009%, 0.000008%, 0.000007%, 0.000006%, 0.000005%, 0.000004%, 0.000003%, 0.000002%, 0.000001%, 0.0000009%, 0.0000008%, 0.0000007%, 0.0000006%, 0.0000005%, 0.0000004%, 0.0000003%, 0.0000002%, 0.0000001%, 0.00000009%, 0.00000008%, 0.00000007%, 0.00000006%, 0.00000005%, 0.00000004%, 0.00000003%, 0.00000002%, 0.00000001%, 0.000000009%, 0.000000008%, 0.000000007%, 0.000000006%, 0.000000005%, 0.000000004%, 0.000000003%, 0.000000002%, or 0.000000001%. In some embodiments about 5%, 10%, 15%, 20%, 25%, 30%, 35%, 40%, 45%, 50%, 60%, 70%, 80%, 90%, or more of the secondary surface 101B is isometric to at most a portion of the flexible film within at most about 10% 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%, 0.0009%, 0.0008%, 0.0007%, 0.0006%, 0.0005%, 0.0004%, 0.0003%, 0.0002%, 0.0001%, 0.000009%, 0.000008%, 0.000007%, 0.000006%, 0.000005%, 0.000004%, 0.000003%, 0.000002%, 0.000001%, 0.0000009%, 0.0000008%, 0.0000007%, 0.0000006%, 0.0000005%, 0.0000004%, 0.0000003%, 0.0000002%, or 0.0000001.

In some embodiments, the surface distortion between two surfaces (for example, a surface of the graded index lens and a surface of the flexible film) is measured as a percentage difference between any line or line segment on one surface (e.g. the surface of graded index lens) and the corresponding line or line segment on another surface (e.g. the surface of a flexible film laminated onto the graded index lens).

In some embodiments, at least a portion of the primary surface 101A and at least a portion of the flexible film have a surface threshold of exactly zero if a distance between the portion of the primary surface 101A and the portion of the flexible film is exactly equal across the portion of the primary surface 101A. In some embodiments, at least a portion of the primary surface 101A and at least a portion of the flexible film have a surface threshold of 10% if a distance between the portion of the primary surface 101A and the portion of the flexible film is within 10% across the portion of the primary surface 101A. In some embodiments, at least a portion of the secondary surface 101B and at least a portion of the flexible film have a surface threshold of exactly zero if a distance between the portion of the secondary surface 101B and the portion of the flexible film is exactly equal across the portion of the secondary surface 101B. In some embodiments, at least a portion of the secondary surface 101B and at least a portion of the flexible film have a surface threshold of 10% if a distance between the portion of the secondary surface 101B and the portion of the flexible film is within 10% across the portion of the secondary surface 101B. In some embodiments, the curvature of the primary surface 101A, the secondary surface, 101B, or both in the first dimension, the second dimension, or both is measured as a local curvature.

In some embodiments, the graded index lens 101 is for use as an eyeglass lens. In some embodiments, the graded index lens 101 comprises an eyeglass frame coupling feature to couple the graded index lens 101 to an eyeglass frame. In some embodiments, at least a portion of the graded index lens 101, the flexible film, or both has a Mohs hardness of about 4 to about 7, a Rockwell M hardness of about 50 to about 120, or both.

In some embodiments, graded index lenses have a front surface, a back surface, or both that are flat or curved in one or more dimensions while maintaining a desired focus. In some embodiments, the front or back surface curved in one or more dimensions aids the focus of the graded index lens, its fit with other components of an optical system (for example an eyeglass frame), improves aesthetics, or any combination thereof. Properly designing a graded index pattern within the graded index lens, enables a desired focus of the graded index lens, even if the shape of the surfaces is not appropriate for the desired focus. The radius of curvature in the one or more dimensions need not be constant across the graded index lens 101. In some embodiments, the graded index lens 101 has a graded index pattern. In some embodiments, a focusing characteristic of the graded index lens 101 having a graded index pattern is at least partially independent of the surface geometry of the graded index lens 101. In some embodiments, a focusing characteristic of the graded index lens 101 having a graded index pattern depends on the surface geometry of the graded index lens 101 and the focus of the graded index lens 101. In some embodiments, a focusing characteristic of the graded index lens 101 having a graded index pattern is dependent on the surface geometry of the graded index lens 101. In some embodiments, the focus provided by the graded index lens is spherical, cylindrical, angled, prismatic, or any Zernike polynomial. In some embodiments, a Zernike polynomials is an equation that describes an aberration of a lens from an ideal spherical shape.

In some embodiments, the graded index lens 101 has at least a primary surface and potentially a secondary surface, wherein the primary surface, the secondary surface, or both are about isometric to a plane; and a flexible film coupled to at least one of the primary surface and the secondary surface of the graded index lens 101. In some embodiments, the focus of the graded index lens is at least partially independent of the curvature of the primary surface, the secondary surface, or both in the first dimension, the second dimension, or both. In some embodiments, a surface of the graded index lens is isometric to the flexible film within at least about 1% (meaning that all possible distances on the film are within about 1% of the corresponding distances on or along the curved surface of the graded index lens 101). In some embodiments, the surface of the graded index lens is isometric to the flexible film within about 1e-9% to about 10%. In some embodiments, the surface of the graded index lens is isometric to the flexible film within about 1e-9% to about 1e-8%, about 1e-9% to about 1e-7%, about 1e-9% to about 0.000001%, about 1e-9% to about 0.00001%, about 1e-9% to about 0.0001%, about 1e-9% to about 0.001%, about 1e-9% to about 0.01%, about 1e-9% to about 0.1%, about 1e-9% to about 1%, about 1e-9% to about 10%, about 1e-8% to about 1e-7%, about 1e-8% to about 0.000001%, about 1e-8% to about 0.00001%, about 1e-8% to about 0.0001%, about 1e-8% to about 0.001%, about 1e-8% to about 0.01%, about 1e-8% to about 0.1%, about 1e-8% to about 1%, about 1e-8% to about 10%, about 1e-7% to about 0.000001%, about 1e-7% to about 0.00001%, about 1e-7% to about 0.0001%, about 1e-7% to about 0.001%, about 1e-7% to about 0.01%, about 1e-7% to about 0.1%, about 1e-7% to about 1%, about 1e-7% to about 10%, about 0.000001% to about 0.00001%, about 0.000001% to about 0.0001%, about 0.000001% to about 0.001%, about 0.000001% to about 0.01%, about 0.000001% to about 0.1%, about 0.000001% to about 1%, about 0.000001% to about 10%, about 0.00001% to about 0.0001%, about 0.00001% to about 0.001%, about 0.00001% to about 0.01%, about 0.00001% to about 0.1%, about 0.00001% to about 1%, about 0.00001% to about 10%, about 0.0001% to about 0.001%, about 0.0001% to about 0.01%, about 0.0001% to about 0.1%, about 0.0001% to about 1%, about 0.0001% to about 10%, about 0.001% to about 0.01%, about 0.001% to about 0.1%, about 0.001% to about 1%, about 0.001% to about 10%, about 0.01% to about 0.1%, about 0.01% to about 1%, about 0.01% to about 10%, about 0.1% to about 1%, about 0.1% to about 10%, or about 1% to about 10%. In some embodiments, a surface of the graded index lens is isometric to the flexible film within about 1e-9%, about 1e-8%, about 1e-7%, about 0.000001%, about 0.00001%, about 0.0001%, about 0.001%, about 0.01%, about 0.1%, about 1%, or about 10%. In some embodiments, the surface of the graded index lens is isometric to the flexible film within at least about 1e-9%, about 1e-8%, about 1e-7%, about 0.000001%, about 0.00001%, about 0.0001%, about 0.001%, about 0.01%, about 0.1%, or about 1%. In some embodiments, the surface of the graded index lens is isometric to the flexible film within at most about 1e-8%, about 1e-7%, about 0.000001%, about 0.00001%, about 0.0001%, about 0.001%, about 0.01%, about 0.1%, about 1%, or about 10%. In some embodiments, at least a portion of the primary surface 101A, at least a portion of the secondary surface 101B, or both are not substantially curved in the second dimension. In some embodiments, the primary surface, the secondary surface, or both are curved in a first dimension, the radius of curvature in the first dimension is not constant across the graded index lens 101.

In some embodiments, the curvature of the primary surface and the secondary surface in the first dimension are in the same direction. In some embodiments, the curvature of the primary surface and the secondary surface in the first dimension are perpendicular to each other. In some embodiments, the primary surface, the secondary surface, or both are further curved in a second dimension perpendicular to the first dimension. In some embodiments, at least a portion of the local curvature of the primary surface, the secondary surface, or both in the second dimension has a radius of about 0.5 m to about 1,000 m. In some embodiments, at least a portion of the local curvature of the primary surface, the secondary surface, or both in the second dimension has a radius of about 0.5 m to about 1 m, about 0.5 m to about 2 m, about 0.5 m to about 5 m, about 0.5 m to about 10 m, about 0.5 m to about 20 m, about 0.5 m to about 50 m, about 0.5 m to about 100 m, about 0.5 m to about 200 m, about 0.5 m to about 500 m, about 0.5 m to about 1,000 m, about 1 m to about 2 m, about 1 m to about 5 m, about 1 m to about 10 m, about 1 m to about 20 m, about 1 m to about 50 m, about 1 m to about 100 m, about 1 m to about 200 m, about 1 m to about 500 m, about 1 m to about 1,000 m, about 2 m to about 5 m, about 2 m to about 10 m, about 2 m to about 20 m, about 2 m to about 50 m, about 2 m to about 100 m, about 2 m to about 200 m, about 2 m to about 500 m, about 2 m to about 1,000 m, about 5 m to about 10 m, about 5 m to about 20 m, about 5 m to about 50 m, about 5 m to about 100 m, about 5 m to about 200 m, about 5 m to about 500 m, about 5 m to about 1,000 m, about 10 m to about 20 m, about 10 m to about 50 m, about 10 m to about 100 m, about 10 m to about 200 m, about 10 m to about 500 m, about 10 m to about 1,000 m, about 20 m to about 50 m, about 20 m to about 100 m, about 20 m to about 200 m, about 20 m to about 500 m, about 20 m to about 1,000 m, about 50 m to about 100 m, about 50 m to about 200 m, about 50 m to about 500 m, about 50 m to about 1,000 m, about 100 m to about 200 m, about 100 m to about 500 m, about 100 m to about 1,000 m, about 200 m to about 500 m, about 200 m to about 1,000 m, or about 500 m to about 1,000 m. In some embodiments, at least a portion of the local curvature of the primary surface, the secondary surface, or both in the second dimension has a radius of about 0.5 m, about 1 m, about 2 m, about 5 m, about 10 m, about 20 m, about 50 m, about 100 m, about 200 m, about 500 m, or about 1,000 m. In some embodiments, at least a portion of the local curvature of the primary surface, the secondary surface, or both in the second dimension has a radius of at least about 0.5 m, about 1 m, about 2 m, about 5 m, about 10 m, about 20 m, about 50 m, about 100 m, about 200 m, or about 500 m. In some embodiments, at least a portion of the local curvature of the primary surface, the secondary surface, or both in the second dimension has a radius of at most about 1 m, about 2 m, about 5 m, about 10 m, about 20 m, about 50 m, about 100 m, about 200 m, about 500 m, or about 1,000 m. In some embodiments, the flexible film comprises a flexible glass film. In some embodiments, the flexible glass film further comprises an anti-reflective film on at least a portion of an outer surface, at least a portion of an inner surface, or both. In some embodiments, the flexible glass film is index matched to the graded index. In some embodiments, the flexible film comprises a flexible polymer film. In some embodiments, the flexible polymer film further comprises an anti-reflective film on at least a portion of an outer surface, at least a portion of an inner surface, or both. In some embodiments, the flexible polymer film is index matched to the graded index lens. In some embodiments, the flexible polymer film further comprises a hard coat between at least a portion of the polymer film and the anti-reflective film. In some embodiments, the laminated graded index lens further comprises an oleophobic or hydrophobic coating. In some embodiments, the flexible film comprises multiple layers of flexible glass film(s) or polymer film(s). In some embodiments, a percentage of the primary or secondary surface of the graded index lens that is covered by the flexible film is about 5% to about 99%. In some embodiments, a percentage of the primary or secondary surface of the graded index lens that is covered by the flexible film is about 5% to about 10%, about 5% to about 20%, about 5% to about 30%, about 5% to about 40%, about 5% to about 50%, about 5% to about 70%, about 5% to about 80%, about 5% to about 90%, about 5% to about 99%, about 10% to about 20%, about 10% to about 30%, about 10% to about 40%, about 10% to about 50%, about 10% to about 70%, about 10% to about 80%, about 10% to about 90%, about 10% to about 99%, about 20% to about 30%, about 20% to about 40%, about 20% to about 50%, about 20% to about 70%, about 20% to about 80%, about 20% to about 90%, about 20% to about 99%, about 30% to about 40%, about 30% to about 50%, about 30% to about 70%, about 30% to about 80%, about 30% to about 90%, about 30% to about 99%, about 40% to about 50%, about 40% to about 70%, about 40% to about 80%, about 40% to about 90%, about 40% to about 99%, about 50% to about 70%, about 50% to about 80%, about 50% to about 90%, about 50% to about 99%, about 70% to about 80%, about 70% to about 90%, about 70% to about 99%, about 80% to about 90%, about 80% to about 99%, or about 90% to about 99%. In some embodiments, a percentage of the primary or secondary surface of the graded index lens that is covered by the flexible film is about 5%, about 10%, about 20%, about 30%, about 40%, about 50%, about 70%, about 80%, about 90%, or about 99%. In some embodiments, a percentage of the primary or secondary surface of the graded index lens that is covered by the flexible film is at least about 5%, about 10%, about 20%, about 30%, about 40%, about 50%, about 70%, about 80%, or about 90%. In some embodiments, a percentage of the primary or secondary surface of the graded index lens that is covered by the flexible film is at most about 10%, about 20%, about 30%, about 40%, about 50%, about 70%, about 80%, about 90%, or about 99%. In some embodiments, the graded index lens 101 is for use as an eyeglass lens, camera, microscope, telescope, rifle scope, endoscope, scuba goggles, swim goggles, safety goggles, sunglasses, welders goggles, or missile. In some embodiments, the laminated graded index lens has a focus of about −20D to about 20D. In some embodiments, the laminated graded index lens has a spherical component of focus of about −20D to about −15D, about −20D to about −10D, about −20D to about −5D, about −20D to about −1D, about −20D to about 0D, about −20D to about 1D, about −20D to about 5D, about −20D to about 10D, about −20D to about 15D, about −20D to about 20D, about −15D to about −10D, about −15D to about −5D, about −15D to about −1D, about −15D to about 0D, about −15D to about 1D, about −15D to about 5D, about −15D to about 10D, about −15D to about 15D, about −15D to about 20D, about −10D to about −5D, about −10D to about −1D, about −10D to about 0D, about −10D to about 1D, about −10D to about 5D, about −10D to about 10D, about −10D to about 15D, about −10D to about 20D, about −5D to about −1D, about −5D to about 0D, about −5D to about 1D, about −5D to about 5D, about −5D to about 10D, about −5D to about 15D, about −5D to about 20D, about −1D to about 0D, about −1D to about 1D, about −1D to about 5D, about −1D to about 10D, about −1D to about 15D, about −1D to about 20D, about 0D to about 1D, about 0D to about 5D, about 0D to about 10D, about 0D to about 15D, about 0D to about 20D, about 1D to about 5D, about 1D to about 10D, about 1D to about 15D, about 1D to about 20D, about 5D to about 10D, about 5D to about 15D, about 5D to about 20D, about 10D to about 15D, about 10D to about 20D, or about 15D to about 20D. In some embodiments, the laminated graded index lens has a spherical component of focus of about −20D, about −15D, about −10D, about −5D, about −1D, about 0D, about 1D, about 5D, about 10D, about 15D, or about 20D. In some embodiments, the laminated graded index lens has a spherical component of focus of at least about −20D, about −15D, about −10D, about −5D, about −1D, about 0D, about 1D, about 5D, about 10D, or about 15D. In some embodiments, the laminated graded index lens has a spherical component of focus of at most about −15D, about −10D, about −5D, about −1D, about 0D, about 1D, about 5D, about 10D, about 15D, or about 20D. In some embodiments, the laminated graded index lens has an astigmatism correction of about 0D to about 20D. In some embodiments, the laminated graded index lens has an astigmatism correction of about 0D to about 1D, about 0D to about 2D, about 0D to about 4D, about 0D to about 6D, about 0D to about 8D, about 0D to about 10D, about 0D to about 12D, about 0D to about 14D, about 0D to about 16D, about 0D to about 18D, about 0D to about 20D, about 1D to about 2D, about 1D to about 4D, about 1D to about 6D, about 1D to about 8D, about 1D to about 10D, about 1D to about 12D, about 1D to about 14D, about 1D to about 16D, about 1D to about 18D, about 1D to about 20D, about 2D to about 4D, about 2D to about 6D, about 2D to about 8D, about 2D to about 10D, about 2D to about 12D, about 2D to about 14D, about 2D to about 16D, about 2D to about 18D, about 2D to about 20D, about 4D to about 6D, about 4D to about 8D, about 4D to about 10D, about 4D to about 12D, about 4D to about 14D, about 4D to about 16D, about 4D to about 18D, about 4D to about 20D, about 6D to about 8D, about 6D to about 10D, about 6D to about 12D, about 6D to about 14D, about 6D to about 16D, about 6D to about 18D, about 6D to about 20D, about 8D to about 10D, about 8D to about 12D, about 8D to about 14D, about 8D to about 16D, about 8D to about 18D, about 8D to about 20D, about 10D to about 12D, about 10D to about 14D, about 10D to about 16D, about 10D to about 18D, about 10D to about 20D, about 12D to about 14D, about 12D to about 16D, about 12D to about 18D, about 12D to about 20D, about 14D to about 16D, about 14D to about 18D, about 14D to about 20D, about 16D to about 18D, about 16D to about 20D, or about 18D to about 20D. In some embodiments, the laminated graded index lens has an astigmatism correction of about 0D, about 1D, about 2D, about 4D, about 6D, about 8D, about 10D, about 12D, about 14D, about 16D, about 18D, or about 20D. In some embodiments, the laminated graded index lens has an astigmatism correction of at least about 0D, about 1D, about 2D, about 4D, about 6D, about 8D, about 10D, about 12D, about 14D, about 16D, or about 18D. In some embodiments, the laminated graded index lens has an astigmatism correction of at most about 1D, about 2D, about 4D, about 6D, about 8D, about 10D, about 12D, about 14D, about 16D, about 18D, or about 20D. In some embodiments, the laminated graded index lens has a prism correction of about 0D to about 20D. In some embodiments, the laminated graded index lens has a prism correction of about 0D to about 1D, about 0D to about 2D, about 0D to about 4D, about 0D to about 6D, about 0D to about 8D, about 0D to about 10D, about 0D to about 12D, about 0D to about 14D, about 0D to about 16D, about 0D to about 18D, about 0D to about 20D, about 1D to about 2D, about 1D to about 4D, about 1D to about 6D, about 1D to about 8D, about 1D to about 10D, about 1D to about 12D, about 1D to about 14D, about 1D to about 16D, about 1D to about 18D, about 1D to about 20D, about 2D to about 4D, about 2D to about 6D, about 2D to about 8D, about 2D to about 10D, about 2D to about 12D, about 2D to about 14D, about 2D to about 16D, about 2D to about 18D, about 2D to about 20D, about 4D to about 6D, about 4D to about 8D, about 4D to about 10D, about 4D to about 12D, about 4D to about 14D, about 4D to about 16D, about 4D to about 18D, about 4D to about 20D, about 6D to about 8D, about 6D to about 10D, about 6D to about 12D, about 6D to about 14D, about 6D to about 16D, about 6D to about 18D, about 6D to about 20D, about 8D to about 10D, about 8D to about 12D, about 8D to about 14D, about 8D to about 16D, about 8D to about 18D, about 8D to about 20D, about 10D to about 12D, about 10D to about 14D, about 10D to about 16D, about 10D to about 18D, about 10D to about 20D, about 12D to about 14D, about 12D to about 16D, about 12D to about 18D, about 12D to about 20D, about 14D to about 16D, about 14D to about 18D, about 14D to about 20D, about 16D to about 18D, about 16D to about 20D, or about 18D to about 20D. In some embodiments, the laminated graded index lens has a prism correction of about 0D, about 1D, about 2D, about 4D, about 6D, about 8D, about 10D, about 12D, about 14D, about 16D, about 18D, or about 20D. In some embodiments, the laminated graded index lens has a prism correction of at least about 0D, about 1D, about 2D, about 4D, about 6D, about 8D, about 10D, about 12D, about 14D, about 16D, or about 18D. In some embodiments, the laminated graded index lens has a prism correction of at most about 1D, about 2D, about 4D, about 6D, about 8D, about 10D, about 12D, about 14D, about 16D, about 18D, or about 20D.

In some embodiments, the graded index lens is used for eyeglasses and includes an anti-reflective coating, an oleophobic coating, a hydrophobic coating, or any combination thereof. In some embodiments, the graded index has a density of about 1.2 g/cm³ to about 2.2 g/cm³. In some embodiments, the graded index has a density of about 1.2 g/cm³ to about 1.3 g/cm³, about 1.2 g/cm³ to about 1.4 g/cm³, about 1.2 g/cm³ to about 1.5 g/cm³, about 1.2 g/cm³ to about 1.6 g/cm³, about 1.2 g/cm³ to about 1.7 g/cm³, about 1.2 g/cm³ to about 1.8 g/cm³, about 1.2 g/cm³ to about 1.9 g/cm³, about 1.2 g/cm³ to about 2 g/cm³, about 1.2 g/cm³ to about 2.1 g/cm³, about 1.2 g/cm³ to about 2.2 g/cm³, about 1.3 g/cm³ to about 1.4 g/cm³, about 1.3 g/cm³ to about 1.5 g/cm³, about 1.3 g/cm³ to about 1.6 g/cm³, about 1.3 g/cm³ to about 1.7 g/cm³, about 1.3 g/cm³ to about 1.8 g/cm³, about 1.3 g/cm³ to about 1.9 g/cm³, about 1.3 g/cm³ to about 2 g/cm³, about 1.3 g/cm³ to about 2.1 g/cm³, about 1.3 g/cm³ to about 2.2 g/cm³, about 1.4 g/cm³ to about 1.5 g/cm³, about 1.4 g/cm³ to about 1.6 g/cm³, about 1.4 g/cm³ to about 1.7 g/cm³, about 1.4 g/cm³ to about 1.8 g/cm³, about 1.4 g/cm³ to about 1.9 g/cm³, about 1.4 g/cm³ to about 2 g/cm³, about 1.4 g/cm³ to about 2.1 g/cm³, about 1.4 g/cm³ to about 2.2 g/cm³, about 1.5 g/cm³ to about 1.6 g/cm³, about 1.5 g/cm³ to about 1.7 g/cm³, about 1.5 g/cm³ to about 1.8 g/cm³, about 1.5 g/cm³ to about 1.9 g/cm³, about 1.5 g/cm³ to about 2 g/cm³, about 1.5 g/cm³ to about 2.1 g/cm³, about 1.5 g/cm³ to about 2.2 g/cm³, about 1.6 g/cm³ to about 1.7 g/cm³, about 1.6 g/cm³ to about 1.8 g/cm³, about 1.6 g/cm³ to about 1.9 g/cm³, about 1.6 g/cm³ to about 2 g/cm³, about 1.6 g/cm³ to about 2.1 g/cm³, about 1.6 g/cm³ to about 2.2 g/cm³, about 1.7 g/cm³ to about 1.8 g/cm³, about 1.7 g/cm³ to about 1.9 g/cm³, about 1.7 g/cm³ to about 2 g/cm³, about 1.7 g/cm³ to about 2.1 g/cm³, about 1.7 g/cm³ to about 2.2 g/cm³, about 1.8 g/cm³ to about 1.9 g/cm³, about 1.8 g/cm³ to about 2 g/cm³, about 1.8 g/cm³ to about 2.1 g/cm³, about 1.8 g/cm³ to about 2.2 g/cm³, about 1.9 g/cm³ to about 2 g/cm³, about 1.9 g/cm³ to about 2.1 g/cm³, about 1.9 g/cm³ to about 2.2 g/cm³, about 2 g/cm³ to about 2.1 g/cm³, about 2 g/cm³ to about 2.2 g/cm³, or about 2.1 g/cm³ to about 2.2 g/cm³. In some embodiments, the graded index has a density of about 1.2 g/cm³, about 1.3 g/cm³, about 1.4 g/cm³, about 1.5 g/cm³, about 1.6 g/cm³, about 1.7 g/cm³, about 1.8 g/cm³, about 1.9 g/cm³, about 2 g/cm³, about 2.1 g/cm³, or about 2.2 g/cm³. In some embodiments, the graded index has a density of at least about 1.2 g/cm³, about 1.3 g/cm³, about 1.4 g/cm³, about 1.5 g/cm³, about 1.6 g/cm³, about 1.7 g/cm³, about 1.8 g/cm³, about 1.9 g/cm³, about 2 g/cm³, or about 2.1 g/cm³. In some embodiments, the graded index has a density of at most about 1.3 g/cm³, about 1.4 g/cm³, about 1.5 g/cm³, about 1.6 g/cm³, about 1.7 g/cm³, about 1.8 g/cm³, about 1.9 g/cm³, about 2 g/cm³, about 2.1 g/cm³, or about 2.2 g/cm³.

In some embodiments, the graded index has a thickness of about 0.5 mm to about 10 mm. In some embodiments, the graded index has a thickness of about 0.5 mm to about 1 mm, about 0.5 mm to about 1.5 mm, about 0.5 mm to about 2 mm, about 0.5 mm to about 2.5 mm, about 0.5 mm to about 3 mm, about 0.5 mm to about 4 mm, about 0.5 mm to about 5 mm, about 0.5 mm to about 6 mm, about 0.5 mm to about 8 mm, about 0.5 mm to about 10 mm, about 1 mm to about 1.5 mm, about 1 mm to about 2 mm, about 1 mm to about 2.5 mm, about 1 mm to about 3 mm, about 1 mm to about 4 mm, about 1 mm to about 5 mm, about 1 mm to about 6 mm, about 1 mm to about 8 mm, about 1 mm to about 10 mm, about 1.5 mm to about 2 mm, about 1.5 mm to about 2.5 mm, about 1.5 mm to about 3 mm, about 1.5 mm to about 4 mm, about 1.5 mm to about 5 mm, about 1.5 mm to about 6 mm, about 1.5 mm to about 8 mm, about 1.5 mm to about 10 mm, about 2 mm to about 2.5 mm, about 2 mm to about 3 mm, about 2 mm to about 4 mm, about 2 mm to about 5 mm, about 2 mm to about 6 mm, about 2 mm to about 8 mm, about 2 mm to about 10 mm, about 2.5 mm to about 3 mm, about 2.5 mm to about 4 mm, about 2.5 mm to about 5 mm, about 2.5 mm to about 6 mm, about 2.5 mm to about 8 mm, about 2.5 mm to about 10 mm, about 3 mm to about 4 mm, about 3 mm to about 5 mm, about 3 mm to about 6 mm, about 3 mm to about 8 mm, about 3 mm to about 10 mm, about 4 mm to about 5 mm, about 4 mm to about 6 mm, about 4 mm to about 8 mm, about 4 mm to about 10 mm, about 5 mm to about 6 mm, about 5 mm to about 8 mm, about 5 mm to about 10 mm, about 6 mm to about 8 mm, about 6 mm to about 10 mm, or about 8 mm to about 10 mm. In some embodiments, the graded index has a thickness of about 0.5 mm, about 1 mm, about 1.5 mm, about 2 mm, about 2.5 mm, about 3 mm, about 4 mm, about 5 mm, about 6 mm, about 8 mm, or about 10 mm. In some embodiments, the graded index has a thickness of at least about 0.5 mm, about 1 mm, about 1.5 mm, about 2 mm, about 2.5 mm, about 3 mm, about 4 mm, about 5 mm, about 6 mm, or about 8 mm. In some embodiments, the graded index has a thickness of at most about 1 mm, about 1.5 mm, about 2 mm, about 2.5 mm, about 3 mm, about 4 mm, about 5 mm, about 6 mm, about 8 mm, or about 10 mm.

In some embodiments the graded index lens has a maximum thickness of less than about 1.5 mm, a focus of less than about 5D, 4D, 3D, 2D, 1D, or a focus of greater than −1D, −2D, −3D, −4D, or −5D, has a density of less than about 2.1 g/cm³, 2.05 g/cm³, 2.0 g/cm³, 1.95 g/cm³, 1.90 g/cm³, 1.85 g/cm³, 1.80 g/cm³, 1.75 g/cm³, 1.70 g/cm³, 1.65 g/cm³, 1.60 g/cm³, 1.55 g/cm³, 1.50 g/cm³, 1.45 g/cm³, 1.40 g/cm³, 1.35 g/cm³, 1.30 g/cm³, 1.25 g/cm³, 1.20 g/cm³, or 1.15 g/cm³ and said lenses can be used for eyeglasses.

In some embodiments the graded index lens used for eyeglasses (which may include an anti-reflective coating, an oleophobic coating, a hydrophobic coating, or any combination thereof), said lens having a maximum thickness less than about 2 mm, a focus of less than about 10D, 9D, 8D, 7D, 6D, 5D, 4D, 3D, 2D, 1D or greater than about −1D, −2D, −3D, −4D, −5D, −6D, −7D, −8D, −9D, or −10D, has a density less than about 2.1 g/cm³, 2.05 g/cm³, 2.0 g/cm³, 1.95 g/cm³, 1.90 g/cm³, 1.85 g/cm³, 1.80 g/cm³, 1.75 g/cm³, 1.70 g/cm³, 1.65 g/cm³, 1.60 g/cm³, 1.55 g/cm³, 1.50 g/cm³, 1.45 g/cm³, 1.40 g/cm³, 1.35 g/cm³, 1.30 g/cm³, 1.25 g/cm³, 1.20 g/cm³, or 1.15 g/cm³.

In some embodiments the graded index lens used for eyeglasses (which may include an anti-reflective coating, an oleophobic coating, a hydrophobic coating, or any combination thereof), has a maximum thickness less than about 3 mm, a focus of less than about 15D, 14D, 13D, 12D, 11D, 10D, 9D, 8D, 7D, 6D, 5D, 4D, 3D, 2D, 1D or greater than about −1D, −2D, −3D, −4D, −5D, −6D, −7D, −8D, −9D, −10D, −11D, −12D, −13D, −14D, or −15D, and a density less than about 2.1 g/cm³, 2.05 g/cm³, 2.0 g/cm³, 1.95 g/cm³, 1.90 g/cm³, 1.85 g/cm³, 1.80 g/cm³, 1.75 g/cm³, 1.70 g/cm³, 1.65 g/cm³, 1.60 g/cm³, 1.55 g/cm³, 1.50 g/cm³, 1.45 g/cm³, 1.40 g/cm³, 1.35 g/cm³, 1.30 g/cm³, 1.25 g/cm³, 1.20 g/cm³, or 1.15 g/cm³.

In some embodiments the graded index lens used for eyeglasses and having a focus of less than about 5D, 4D, 3D, 2D, 1D, or greater than about −1D, −2D, −3D, −4D, or −5D, and an areal density of less than about 0.5 g/cm², 0.45 g/cm², 0.40 g/cm², 0.35 g/cm², 0.30 g/cm², 0.25 g/cm², 0.20 g/cm², or 0.15 g/cm².

In some embodiments the graded index lens used for eyeglasses (which may include an anti-reflective coating, an oleophobic coating, a hydrophobic coating, or any combination thereof) has a focus of less than about 5D, 4D, 3D, 2D, 1D, or greater than about −1D, −2D, −3D, −4D, or −5D, and an areal density of less than about 0.5 g/cm², 0.45 g/cm², 0.40 g/cm², 0.35 g/cm², 0.30 g/cm², 0.25 g/cm², 0.20 g/cm², or 0.15 g/cm².

### Method of Forming a Laminated Graded Index Lens

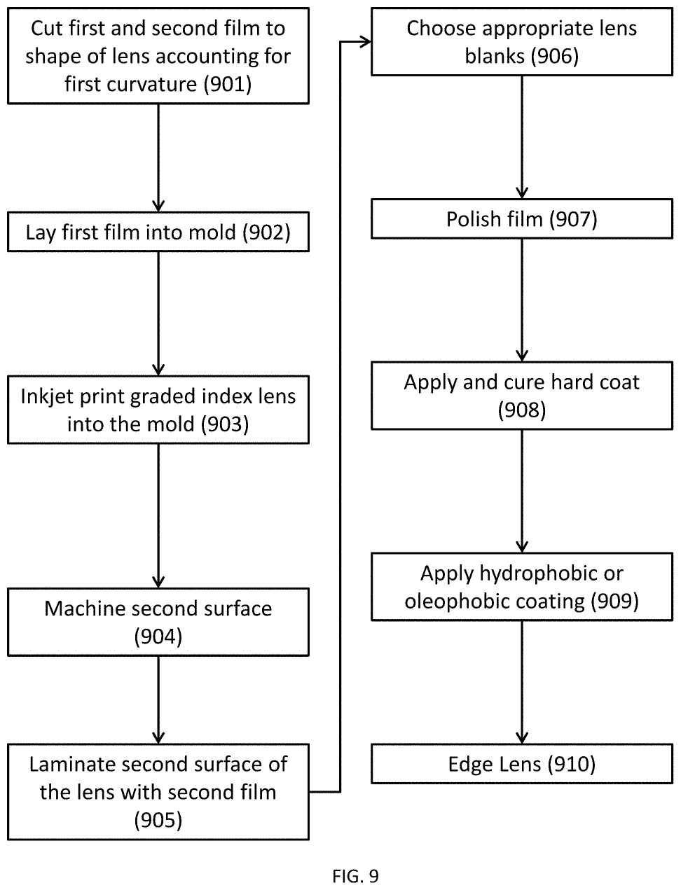

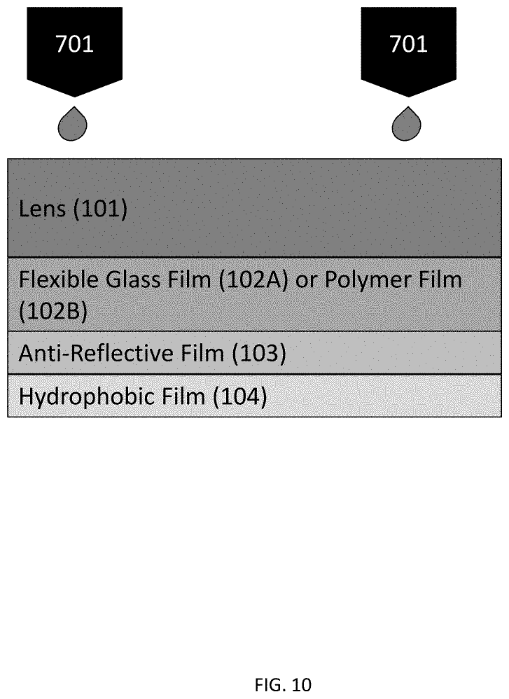

Another aspect provided herein, per FIGS. 9-12, is a method of forming a laminated graded index lens. In some embodiments, the method comprises: printing a graded index lens onto at least a portion of a first flexible film. In some embodiments, the method further comprises coupling a second flexible film onto at least a portion of the graded index lens.

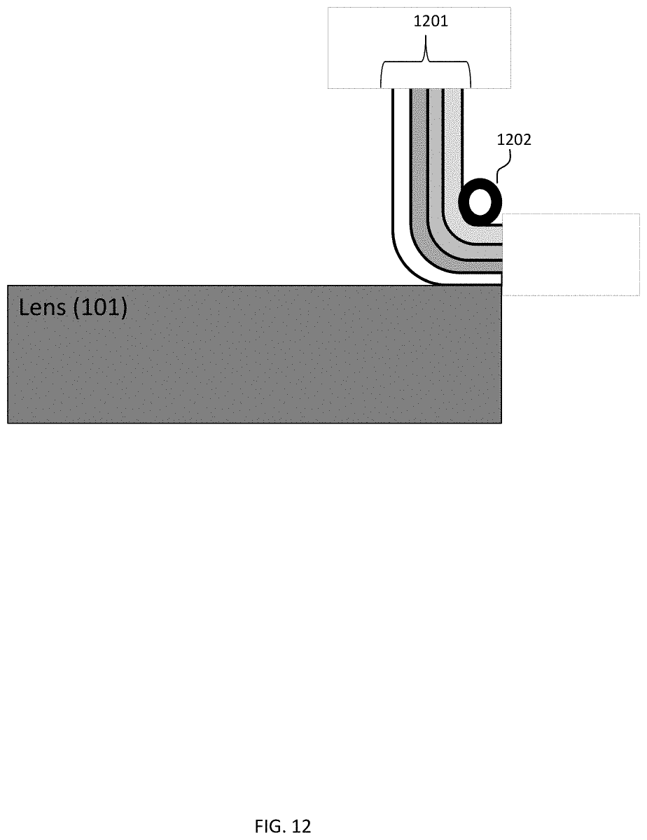

In some embodiments, the printing is performed by an inkjet printer, a 3-dimensional printer, or both. In some embodiments, the printing comprises printing an eyeglass coupling feature onto the graded index lens. In some embodiments, the liquid coating comprises spin coating, dip coating, spray coating, printing, slot die coating, screen printing, vacuum depositing or any combination thereof. In some embodiments, coupling the second flexible film onto the portion of the graded index lens comprises liquid coating the second flexible film onto the graded index lens. In some embodiments, per FIG. 12, coupling the second flexible film 1201 onto the portion of the graded index lens comprises coupling the second flexible film by a roller 1202. In some embodiments, the second flexible film comprises 1, 2, 3, 4, 5, 6, 7, 8, 9, 10 or more layers. In some embodiments, the use of the first flexible film, the second flexible film, or both for forming the laminated graded index lens improves speed, reduces cost, improves precision, improves quality, or any combination thereof. In some embodiments, the use of the first flexible film, the second flexible film, or both is a commercially available flexible film.

In some embodiments, the method further comprises cutting the first flexible film, cutting the second flexible film, or both. In some embodiments, the method further comprises cutting the first flexible film based on a shape of the front face of the graded index lens. In some embodiments, the method further comprises cutting the second flexible film based on a shape of the back face of the graded index lens. In some embodiments, the method further comprises laminating the second surface of the graded index lens with the second flexible film. In some embodiments, the method further comprises polishing the first flexible film, the second flexible film, or both. In some embodiments, the method further comprises cutting the graded index lens.

In some embodiments, the laminated graded index lens comprises a sheet of the graded index lens material, wherein the method comprises coupling the first flexible film to the primary face of the graded index lens, coupling the second flexible film to the secondary face of the graded index lens, and cutting the first flexible film, the second flexible film, and the graded index lens to form individual lenses for an eyeglass. In some embodiments, the method further comprises coating the first flexible film, the second flexible film, or both before the cutting step. In some embodiments, the method further comprises adding another layer of the first flexible film, the second flexible film, or both, before the cutting step. In some embodiments, the method further comprising applying an adhesive before the cutting step. In some embodiments, the method further comprises compressing the graded index lens to ensure adhesion, form the shape, or both, of at least one of the primary surface and the secondary surface before or after the cutting step. In some embodiments, applying the flexible film to a sheet of the graded index lens reduces a production cost, and increases quality and throughput. In some embodiments, applying the flexible film to a sheet of the graded index lens enables customized operation at smaller scales. In some embodiments, applying the flexible film to a sheet of the graded index lens produces lenses at a faster pace due to simplified operations. In some embodiments, cutting the first flexible film, the second flexible film, and the graded index lens to form individual lenses for an eyeglass eliminates the requirement for individual lens holders or frames during production. In some embodiments, cutting the first flexible film, the second flexible film, and the graded index lens to form individual lenses for an eyeglass enables a more consistent coating of the graded index lens by the first flexible film, the second flexible film, or both, as compared to traditional coating processes. In some embodiments, cutting the first flexible film, the second flexible film, and the graded index lens to form individual lenses for an eyeglass prevents particulate from being embedded therein, as with traditional coating processes. In some embodiments, cutting the first flexible film, the second flexible film, and the graded index lens to form individual lenses for an eyeglass eliminates the need for filters to reduce particulates during production. In some embodiments, applying the first flexible film and second flexible film as films increases the strength of the laminated graded index lens. In some embodiments, applying the first flexible film and second flexible film as films reduces the thickness of the laminated graded index lens while maintaining durability. In some embodiments, applying the first flexible film and second flexible film as films prevents shattering of the laminated graded index lens. In some embodiments, the first flexible film, the second flexible film, or both do not wrinkle when applied to the graded index lens.

In some embodiments, once applied to the graded index lens the first flexible film, the second flexible film, or both has a surface roughness of about 0.1 nm to about 35 nm. In some embodiments, once applied to the graded index lens the first flexible film, the second flexible film, or both has a surface roughness of about 0.5 nm to about 1 nm, about 0.5 nm to about 5 nm, about 0.5 nm to about 10 nm, about 0.5 nm to about 15 nm, about 0.5 nm to about 20 nm, about 0.5 nm to about 25 nm, about 0.5 nm to about 30 nm, about 0.5 nm to about 35 nm, about 1 nm to about 5 nm, about 1 nm to about 10 nm, about 1 nm to about 15 nm, about 1 nm to about 20 nm, about 1 nm to about 25 nm, about 1 nm to about 30 nm, about 1 nm to about 35 nm, about 5 nm to about 10 nm, about 5 nm to about 15 nm, about 5 nm to about 20 nm, about 5 nm to about 25 nm, about 5 nm to about 30 nm, about 5 nm to about 35 nm, about 10 nm to about 15 nm, about 10 nm to about 20 nm, about 10 nm to about 25 nm, about 10 nm to about 30 nm, about 10 nm to about 35 nm, about 15 nm to about 20 nm, about 15 nm to about 25 nm, about 15 nm to about 30 nm, about 15 nm to about 35 nm, about 20 nm to about 25 nm, about 20 nm to about 30 nm, about 20 nm to about 35 nm, about 25 nm to about 30 nm, about 25 nm to about 35 nm, or about 30 nm to about 35 nm. In some embodiments, once applied to the graded index lens the first flexible film, the second flexible film, or both has a surface roughness of about 0.5 nm, about 1 nm, about 5 nm, about 10 nm, about 15 nm, about 20 nm, about 25 nm, about 30 nm, or about 35 nm. In some embodiments, once applied to the graded index lens the first flexible film, the second flexible film, or both has a surface roughness of at least about 0.5 nm, about 1 nm, about 5 nm, about 10 nm, about 15 nm, about 20 nm, about 25 nm, or about 30 nm. In some embodiments, once applied to the graded index lens the first flexible film, the second flexible film, or both has a surface roughness of at most about 1 nm, about 5 nm, about 10 nm, about 15 nm, about 20 nm, about 25 nm, about 30 nm, or about 35 nm.

In some embodiments, the method comprises simultaneously coupling the flexible film to two or more graded index lenses after cutting each of the two or more graded lenses. In some embodiments, simultaneously coupling the flexible film to two or more graded index lenses after cutting each of the two or more graded lenses reduces a production cost, and increases quality and throughput. In some embodiments, applying the flexible film to a sheet of the graded index lens enables customized operation at smaller scales. In some embodiments, simultaneously coupling the flexible film to two or more graded index lenses after cutting each of the two or more graded lenses produces lenses at a faster pace due to simplified operations. In some embodiments, simultaneously coupling the flexible film to two or more graded index lenses after cutting each of the two or more graded lenses eliminates the requirement for individual lens holders or frames during production. In some embodiments, simultaneously coupling the flexible film to two or more graded index lenses after cutting each of the two or more graded lenses enables a more consistent coating of the graded index lens by the first flexible film, the second flexible film, or both, as compared to traditional coating processes. In some embodiments, simultaneously coupling the flexible film to two or more graded index lenses after cutting each of the two or more graded lenses prevents particulate from being embedded therein, as with traditional coating processes. In some embodiments, simultaneously coupling the flexible film to two or more graded index lenses after cutting each of the two or more graded lenses eliminates the need for filters to reduce particulates during production. In some embodiments, simultaneously coupling the flexible film to two or more graded index lenses after cutting each of the two or more graded lenses increases the strength of the laminated graded index lens. In some embodiments, simultaneously coupling the flexible film to two or more graded index lenses after cutting each of the two or more graded lenses reduces the thickness of the laminated graded index lens while maintaining durability. In some embodiments, applying the first flexible film and second flexible film as films prevents shattering of the laminated graded index lens.

FIG. 9 shows a flowchart of an exemplary method of forming a laminated graded index lens. As shown, the method comprises: cutting a front film and a back film to the shape of the graded index lens (accounting for front curvature) 901, laying the front film into the mold 902, inkjet printing the graded index lens into the mold 903, machining the secondary surface 904 of the graded index lens, laminating the secondary surface of the graded index lens with the back 905, choosing an appropriate lens blank 906, polishing the back film 907, applying and curing a hard coat 908, applying a hydrophobic or oleophobic coating 909, and edging the graded index lens 910.

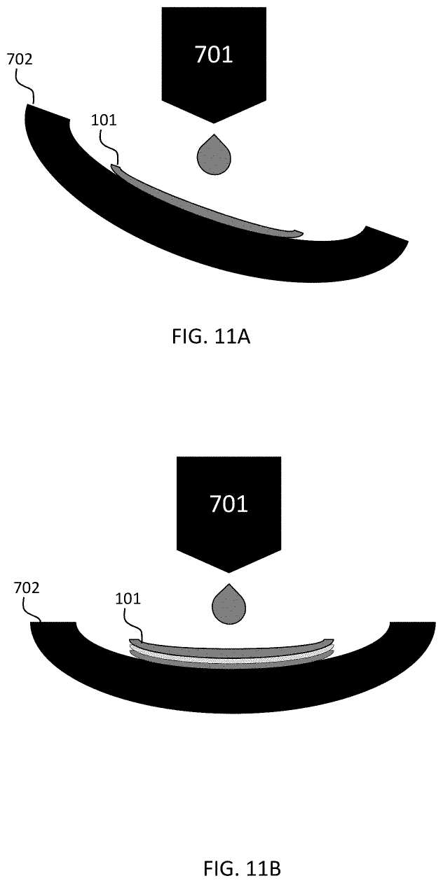

FIG. 11A show a diagram of an exemplary step of inkjet printing the graded index lens 101 onto a mold 702 using an inkjet printer 701. FIG. 11A show a diagram of an exemplary step of inkjet printing the graded index lens 101 onto the first flexible film in the mold 702 using an inkjet printer 701. In some embodiments, per FIG. 11A, the method comprises rotating the mold 702 with respect to the inkjet printer 701 while ink jetting the graded index lens 101 onto the mold 702. In some embodiments, rotating the mold 702 with respect to the inkjet printer 701 while ink jetting the graded index lens 101 onto the mold 702 enables the formation of the secondary surface that is not concentric with the primary surface. In some embodiments, rotating the mold 702 with respect to the inkjet printer 701 while ink jetting the graded index lens 101 onto the mold 702 enables the formation of the secondary surface whose curvature is not in the same direction as the primary surface. In some embodiments, the method comprises printing two or more graded index lenses 101 onto the at least a portion of the first flexible film simultaneously. In some embodiments, the method comprises coupling the second flexible film onto at least a portion of two or more graded index lenses 101 simultaneously. In some embodiments, the method is not performed in clean room.

Another aspect provided herein is a method of forming a laminated graded index lens, the method comprising: coupling a first flexible film onto at least a portion of a primary surface of a graded index lens; and coupling a second flexible film onto at least a portion of a secondary surface of the graded index lens.

In some embodiments, the first flexible film, the second flexible film, or both comprise a polymer film, an anti-reflective film, a hard coat film, a hydrophobic film, a tint film, a polarizer film, a photochromatic film, a UV-blocking film or any combination thereof. In some embodiments, coupling the second flexible film onto the portion of the graded index lens comprises coupling the second flexible film by a roller. In some embodiments, the method comprises printing two or more graded index lenses onto the at least a portion of the first flexible film simultaneously. In some embodiments, the method comprises coupling the second flexible film onto at least a portion of two or more graded index lenses simultaneously. In some embodiments, the method is not performed in clean room.

Another aspect is a method of inserting the laminated graded index lens into an eyeglass frame, the method comprising: receiving the laminated graded index lens; receiving the eyeglass frame; and inserting the laminated graded index lens into the eyeglass frame. Another aspect provided herein is a system comprising: the laminated graded index lens and an optical instrument in contact with the laminated graded index lens. Another aspect provided herein is a system comprising: the laminated graded index lens and an optical instrument in contact with the laminated graded index lens to measure an optical property of the graded index lens. Another aspect provided herein is a manufacturing facility for manufacturing the laminated graded index lens. In some embodiments, the manufacturing facility comprises the optical instrument. Another aspect provided herein is a pair of glasses comprising the laminated graded index lens. In some embodiments, a single pair of glasses comprises two laminated graded index lenses.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 9%, 8%, 7%, 6%, 5%, 4%, 3%, 2%, or 1%.

As used herein, the phrases “at least one” and “one or more”, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the term “clean room” refers to an area configured to reduce airborne particulates, such as dust, airborne organisms, or vaporized particles.

As used herein, the term “increment” in reference to a described range refers to any subset of ranges within the described range. For example, “A-B, including increments therein” refers to any range between X and Y, wherein X is greater than or equal to A, wherein Y is less than or equal to B.

As used herein, the term “meniscus” refers to a lens shape having two opposing sides, wherein one side is convex and the other side in concave. Almost all eyeglass lenses are meniscus shaped.

As used herein, the term “index matched” refers to two substances having an index of refraction within a set threshold. In some embodiments, the set threshold is about 0.2, 0.19, 0.18, 0.17, 0.16, 0.15, 0.14, 0.13, 0.12, 0.11, 0.10, 0.09, 0.08, 0.07, 0.06, 0.05, 0.04, 0.03, 0.02, or 0.01 at a specific wavelength or range of wavelengths for visible light (380 nm to 740 nm).

Two surfaces are said to be isometric if one can be bent (or transformed) into the other without changing intrinsic distances. For example, because a sheet of paper can be rolled into a tube without stretching, the sheet and tube are “locally” isometric—only locally because new, and possibly shorter, routes are created by connecting the two edges of the paper. Similarly, a piece of paper cannot be bent into a sphere without stretching. A Mercator projection of the globe causes significant distortion, with the distortion getting worse farther away from the equator.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A laminated graded index lens comprising:
a) a graded index lens having a primary surface and a secondary surface, wherein the primary surface, the secondary surface, or both are curved in at least a first dimension; and
b) a flexible film coupled to at least one of the primary surface and the secondary surface of the graded index lens.

2. The laminated graded index lens of claim 1, wherein the primary surface, the secondary surface, or both are further curved in a second dimension perpendicular to the first dimension.

3. The laminated graded index lens of claim 2, wherein the curvature of the primary surface and the secondary surface in the first dimension and in the second dimension are in the same direction.

4. The laminated graded index lens of claim 2, wherein the curvature of the primary surface and the secondary surface in the first dimension or in the second dimension are in opposite directions.

5. The laminated graded index lens of any one of claims 2-4, wherein a radius of curvature varies across at least a portion of the primary surface, at least a portion of the secondary surface, or both in the first dimension, the second dimension, or both.

6. The laminated graded index lens of any one of claims 1-5, having a concave surface, a convex surface, or both.

7. The laminated graded index lens of any one of claims 2-6, wherein a focus of the graded index lens is at least partially independent of the curvature of the primary surface, the secondary surface, or both in the first dimension, the second dimension, or both.

8. The laminated graded index lens of claim 7, wherein a focus provided by the graded index lens is spherical, cylindrical, angled, prismatic, or a Zernike polynomial.

9. The laminated graded index lens of any one of claims 1-7, wherein the flexible film is index matched to the graded index lens.

10. The laminated graded index lens of any one of claims 1-9, wherein the flexible film comprises a flexible glass film or a flexible polymer film.

11. The laminated graded index of claim 10, wherein the flexible film further comprises an anti-reflective film, a hydrophobic film, a hard coat film, an oleophobic film, a hydrophobic film, a tint film, a polarizer film, a photochromatic film, a UV-blocking film, or any combination thereof, covering at least a portion of the graded index lens.

12. The laminated graded index of claim 11, comprising two or more of the anti-reflective film, a hydrophobic film, the hard coat film, the oleophobic film, the hydrophobic film, the tint film, the polarizer film, the photochromatic film, or the UV-blocking film.

13. The laminated graded index of claim 11 or 12, comprising the flexible polymer film, and wherein the flexible polymer film comprises PET, PEN, transparent polyimide, polyimide, or any combination thereof.

14. The laminated graded index lens of any one of claims 1-13, wherein at least about 5% of the graded index lens is covered by at least a portion of the flexible film.

15. The laminated graded index lens of any one of claims 1-14, wherein at least a portion of the flexible film is at least partially coupled to at least a portion of the graded index lens by an at least partially optically clear adhesive.

16. The laminated graded index lens of any one of claims 1-15, wherein the graded lens is directly printed onto the flexible film.

17. The laminated graded index lens of any one of claims 1-16, wherein the flexible film comprises one or more portions of the flexible film.

18. The laminated graded index lens of any one of claims 1-17, wherein the graded index lens, the flexible film, or both has a Mohs hardness of about 4 to about 7, a Rockwell M hardness of about 50 to about 120, or both.

19. The laminated graded index lens of any one of claims 1-18, wherein the graded index lens has a spherical component of the focus of greater than about 0.25 diopters, or less than about −0.25 diopters.

20. The laminated graded index lens of any one of claims 1-19, for use as an eyeglass lens.

21. The laminated graded index lens of claim 20, wherein the graded index lens further comprises an eyeglass frame coupling feature configured to couple to an eyeglass frame.

22. The laminated graded index lens of any one of claims 1-21, wherein a surface of the graded index lens is isometric to the flexible film within at most about 10%.

23. A laminated graded index lens comprising:
a. a graded index lens having a primary surface and a secondary surface, wherein the primary surface, the secondary surface, or both are curved in a first dimension; and
b. a flexible film coupled to at least one of the primary surface and the secondary surface of the graded index lens;
wherein the graded index lens has a focus that is at least partially independent of the curvature of the primary surface of the graded index lens, the secondary surface of the graded index lens, or both in the first dimension.

24. The laminated graded index lens of claim 23, wherein the primary surface, the secondary surface, or both are further curved in a second dimension perpendicular to the first dimension.

25. The laminated graded index lens of claim 24, wherein the curvature of the primary surface and the secondary surface in the first dimension or in the second dimension are in the same direction.

26. The laminated graded index lens of claim 24, wherein the curvature of the primary surface and the secondary surface in the first dimension or in the second dimension are in opposite directions.

27. The laminated graded index lens of any one of claims 24-26, wherein a radius of curvature varies across at least a portion of the primary surface, at least a portion of the secondary surface, or both in the first dimension, the second dimension, or both.

28. The laminated graded index lens of any one of claims 23-27, having a concave surface, a convex surface, or both.

29. The laminated graded index lens of any one of claims 23-28, wherein a focus provided by the graded index lens is spherical, cylindrical, angled, prismatic, or a Zernike polynomial.

30. The laminated graded index lens of any one of claims 23-29, wherein the flexible film is index matched to the graded index lens.

31. The laminated graded index lens of any one of claims 23-30, wherein the flexible film comprises a flexible glass film or a flexible polymer film.

32. The laminated graded index of claim 31, wherein the flexible film further comprises an anti-reflective film, a hydrophobic film, a hard coat film, an oleophobic film, a hydrophobic film, a tint film, a polarizer film, a photochromatic film, a UV-blocking film, or any combination thereof, covering at least a portion of the flexible film, the graded index lens, or both.

33. The laminated graded index of claim 32, comprising two or more of the anti-reflective film, a hydrophobic film, the hard coat film, the oleophobic film, the hydrophobic film, the tint film, the polarizer film, the photochromatic film, or the UV-blocking film.

34. The laminated graded index of claim 31, comprising the flexible polymer film, and wherein the flexible polymer film comprises PET, PEN, transparent polyimide, polyimide, or any combination thereof.

35. The laminated graded index lens of any one of claims 23-34, wherein at least about 5% of the graded index lens is covered by at least a portion of the flexible film.

36. The laminated graded index lens of any one of claims 23-35, wherein at least a portion of the flexible film is at least partially coupled to at least a portion of the graded index lens by an at least partially optically clear adhesive.

37. The laminated graded index lens of any one of claims 23-36, wherein the graded lens is directly printed onto the flexible film.

38. The laminated graded index lens of any one of claims 23-37, wherein the graded index lens, the flexible film, or both has a Mohs hardness of about 4 to about 7, a Rockwell M hardness of about 50 to about 120, or both.

39. The laminated graded index lens of any one of claims 23-38, wherein the graded index lens has a spherical component of the focus of greater than about 0.25 diopters, or less than about −0.25 diopters.

40. The laminated graded index lens of any one of claims 23-39, for use as an eyeglass lens.

41. The laminated graded index lens of claim 40, wherein the graded index lens further comprises an eyeglass frame coupling feature configured to couple to an eyeglass frame.

42. The laminated graded index lens of any one of claims 23-41, wherein a surface of the graded index lens is isometric to the flexible film within at most about 10%.

43. A laminated graded index lens comprising:
a) a graded index lens having a primary surface and a secondary surface, wherein the primary surface, the secondary surface, or both are curved in a first dimension; and
b) a flexible film coupled to at least one of the primary surface and the secondary surface of the graded index lens;
wherein the graded index lens is printed onto at least a portion of the first flexible film.

44. The laminated graded index lens of claim 43, wherein the primary surface, the secondary surface, or both are further curved in a second dimension perpendicular to the first dimension.

45. The laminated graded index lens of claim 44, wherein the curvature of the primary surface and the secondary surface in the first dimension or in the second dimension are in the same direction.

46. The laminated graded index lens of claim 45, wherein the curvature of the primary surface and the secondary surface in the first dimension or in the second dimension are in opposite directions.

47. The laminated graded index lens of any one of claims 44-46, wherein a radius of curvature varies across at least a portion of the primary surface, at least a portion of the secondary surface, or both in the first dimension, the second dimension, or both.

48. The laminated graded index lens of any one of claims 43-47, having a concave surface, a convex surface, or both.

49. The laminated graded index lens of any one of claims 44-48, wherein a focus of the graded index lens is at least partially independent of the curvature of the primary surface, the secondary surface, or both in the first dimension, the second dimension, or both.

50. The laminated graded index lens of claim 49, wherein a focus provided by the graded index lens is spherical, cylindrical, angled, prismatic, or a Zernike polynomial.

51. The laminated graded index lens of any one of claims 43-50, wherein the flexible film is index matched to the graded index lens.

52. The laminated graded index lens of any one of claims 43-51, wherein the flexible film comprises a flexible glass film or a flexible polymer film.

53. The laminated graded index of claim 52, wherein the flexible film further comprises an anti-reflective film, a hydrophobic film, a hard coat film, an oleophobic film, a hydrophobic film, or any combination thereof, covering at least a portion of the flexible film, the graded index lens, or both.

54. The laminated graded index of claim 53, comprising two or more of the anti-reflective film, a hydrophobic film, the hard coat film, the oleophobic film, the hydrophobic film, the tint film, the polarizer film, the photochromatic film, or the UV-blocking film.

55. The laminated graded index of claim 52, comprising the flexible polymer film, and wherein the flexible polymer film comprises PET, PEN, transparent polyimide, polyimide, or any combination thereof.

56. The laminated graded index lens of any one of claims 43-55, wherein at least about 5% of the graded index lens is covered by at least a portion of the flexible film.

57. The laminated graded index lens of any one of claims 43-56, wherein at least a portion of the flexible film is at least partially coupled to at least a portion of the graded index lens by an at least partially optically clear adhesive.

58. The laminated graded index lens of any one of claims 43-57, wherein the graded index lens, the flexible film, or both has a Mohs hardness of about 4 to about 7, a Rockwell M hardness of about 50 to about 120, or both.

59. The laminated graded index lens of any one of claims 43-58, wherein the graded index lens has a spherical component of the focus of greater than about 0.25 diopters, or less than about −0.25 diopters.

60. The laminated graded index lens of any one of claims 43-59, for use as an eyeglass lens.

61. The laminated graded index lens of claim 60, wherein the graded index lens further comprises an eyeglass frame coupling feature configured to couple to an eyeglass frame.

62. The laminated graded index lens of any one of claims 43-61, wherein a surface of the graded index lens is isometric to the flexible film within at least most about 10%.

63. An eyeglass comprising a laminated graded index lens, the laminated graded index lens comprising:
a. a graded index lens having a primary surface and a secondary surface, wherein the primary surface, the secondary surface, or both are curved in a first dimension; and
b. a flexible film coupled to at least one of the primary surface and the secondary surface of the graded index lens;
wherein the graded index lens has a thickness less than about 4.5 mm, a spherical component of focus of less than about 15D or greater than about −15D, a density less than about 2.1 g/cm³.

64. A pair of eyeglasses comprising:
a) receiving the laminated graded index lens of any one of claim 1-22, 23-42, 43-62, or 63; and
b) an eyeglass frame.

65. A method of forming a pair of eyeglasses, the method comprising:
a) receiving the laminated graded index lens of any one of claim 1-22, 23-42, 43-62, or 63;
b) receiving an eyeglass frame; and
c) inserting the laminated graded index lens into the eyeglass frame.

66. A system comprising:
a) the laminated graded index lens of any one of claim 1-22, 23-42, 43-62, or 63; and
b) an optical instrument in contact with the laminated graded index lens.

67. A manufacturing facility for manufacturing the laminated graded index lens of any one of claim 1-22, 23-42, 43-62, or 63.

68. A method of forming a laminated graded index lens, the method comprising:
a) printing a graded index lens onto at least a portion of a first flexible film; and
b) coupling a second flexible film onto at least a portion of the graded index lens.

69. The method of claim 68, wherein the printing is performed by an inkjet printer, a 3-dimensional printer, or both.

70. The method of claim 68 or 69, wherein the printing comprises printing an eyeglass coupling feature onto the graded index lens.

71. The method of any one of claims 68-70, wherein coupling the second flexible film onto the portion of the graded index lens comprises coupling the second flexible film by a roller.

72. The method of any one of claims 68-71, comprising printing two or more graded index lenses onto the at least a portion of the first flexible film simultaneously.

73. The method of any one of claims 68-72, comprising coupling the second flexible film onto at least a portion of two or more graded index lenses simultaneously.

74. The method of any one of claims 68-72, wherein the graded index lens comprises a concave surface, a convex surface, or both.

75. The method of any one of claims 68-42, wherein the first flexible film, the second flexible film, or both are index matched to the graded index lens.

76. The method of any one of claims 68-75, wherein the first flexible film, the second flexible film, or both comprises a flexible glass film or a flexible polymer film.

77. The method of claim 76, wherein the first flexible film, the second flexible film, or both further comprises an anti-reflective film, a hydrophobic film, a hard coat film, an oleophobic film, a hydrophobic film, or any combination thereof, covering at least a portion of the flexible film, the graded index lens, or both.

78. The method of claim 77, wherein the first flexible film, the second flexible film, or both comprise two or more of the anti-reflective film, a hydrophobic film, the hard coat film, the oleophobic film, the hydrophobic film, the tint film, the polarizer film, the photochromatic film, or the UV-blocking film.

79. The method of claim 76, herein the first flexible film, the second flexible film, or both comprise the flexible polymer film, and wherein the flexible polymer film comprises PET, PEN, transparent polyimide, polyimide, or any combination thereof.

80. The method of any one of claims 68-79, wherein at least about 5% of the graded index lens is covered by at least a portion of the first flexible film, the second flexible film, or both.

81. The method of any one of claims 68-80, wherein at least a portion of the first flexible film, the second flexible film, or both is at least partially coupled to at least a portion of the graded index lens by an at least partially optically clear adhesive.

82. The method of any one of claims 68-81, wherein the graded index lens, the first flexible film, the second flexible film, or any combination thereof has a Mohs hardness of about 4 to about 7, a Rockwell M hardness of about 50 to about 120, or both.

83. The method of any one of claims 68-82, wherein the graded index lens has a spherical component of the focus of greater than about 0.25 diopters, or less than about −0.25 diopters.

84. The method of claim 83, wherein the graded index lens further comprises an eyeglass frame coupling feature configured to couple to an eyeglass frame.

85. The method lens of any one of claims 68-84, wherein a surface of the graded index lens is isometric to the flexible film within at least most about 10%.

86. The method of any one of claims 68-85, not performed in clean room.

87. A method of forming a laminated graded index lens, the method comprising:
a) coupling a first flexible film onto at least a portion of a primary surface of a graded index lens; and
b) coupling a second flexible film onto at least a portion of a secondary surface of the graded index lens.

88. The method of claim 87, wherein the first flexible film, the second flexible film, or both comprise a polymer film, an anti-reflective film, a hard coat film, a hydrophobic film, a tint film, a polarizer film, a photochromatic film, a UV-blocking film or any combination thereof.

89. The method of claim 87 or 88, wherein coupling the first flexible film, the second flexible film, or both onto the portion of the graded index lens comprises coupling the first flexible film, the second flexible film, or both by a roller.

90. The method of any one of claims 87-89, comprising coupling two or more graded index lenses onto the at least a portion of the first flexible film simultaneously.

91. The method of any one of claims 87-90, comprising coupling the second flexible film onto at least a portion of two or more graded index lenses simultaneously.

92. The method of any one of claims 87-91, wherein the graded index lens comprises a concave surface, a convex surface, or both.

93. The method of any one of claims 87-92, wherein the first flexible film, the second flexible film, or both are index matched to the graded index lens.

94. The method of any one of claims 87-93, wherein the first flexible film, the second flexible film, or both comprises a flexible glass film or a flexible polymer film.

95. The method of claim 94, wherein the first flexible film, the second flexible film, or both further comprises an anti-reflective film, a hydrophobic film, a hard coat film, an oleophobic film, a hydrophobic film, or any combination thereof, covering at least a portion of the flexible film, the graded index lens, or both.

96. The method of claim 95, wherein the first flexible film, the second flexible film, or both comprise two or more of the anti-reflective film, a hydrophobic film, the hard coat film, the oleophobic film, the hydrophobic film, the tint film, the polarizer film, the photochromatic film, or the UV-blocking film.

97. The method of claim 94, wherein the first flexible film, the second flexible film, or both comprise the flexible polymer film, and wherein the flexible polymer film comprises PET, PEN, transparent polyimide, polyimide, or any combination thereof.

98. The method of any one of claims 87-97, wherein at least about 5% of the graded index lens is covered by at least a portion of the first flexible film, the second flexible film, or both.

99. The method of any one of claims 87-98, wherein at least a portion of the first flexible film, the second flexible film, or both is at least partially coupled to at least a portion of the graded index lens by an at least partially optically clear adhesive.

100. The method of any one of claims 87-99, wherein the graded index lens, the first flexible film, the second flexible film, or any combination thereof has a Mohs hardness of about 4 to about 7, a Rockwell M hardness of about 50 to about 120, or both.

101. The method of any one of claims 87-100, wherein the graded index lens has a spherical component of the focus of greater than about 0.25 diopters, or less than about −0.25 diopters.

102. The method of claim 101, wherein the graded index lens further comprises an eyeglass frame coupling feature configured to couple to an eyeglass frame.

103. The method lens of any one of claims 87-102, wherein a surface of the graded index lens is isometric to the flexible film within at least most about 10%.

104. The method of any one of claims 87-103, not performed in clean room.
